(19) United States
(12) Patent Application Publication
(10) Pub. No.: US 2025/0138251 A1
(43) Pub. Date: May 1, 2025

(54) Optical Module

(71) Applicant: HISENSE BROADBAND MULTIMEDIA TECHNOLOGIES CO., LTD., Qingdao (CN)

(72) Inventors: Sigeng YANG, Qingdao (CN); Long ZHENG, Qingdao (CN); Fabu XU, Qingdao (CN)

(73) Assignee: HISENSE BROADBAND MULTIMEDIA TECHNOLOGIES CO., LTD., Qingdao (CN)

(21) Appl. No.: 19/004,211

(22) Filed: Dec. 27, 2024

Related U.S. Application Data
(63) Continuation-in-part of application No. PCT/CN2023/120024, filed on Sep. 20, 2023.

(30) Foreign Application Priority Data
Jun. 30, 2023 (CN) 202310796445.4
Jun. 30, 2023 (CN) 202310796688.8
Jun. 30, 2023 (CN) 202310796703.9
Jun. 30, 2023 (CN) 202310796764.5
Jun. 30, 2023 (CN) 202321704612.X

(51) Int. Cl. G02B 6/38

(52) U.S. Cl. CPC G02B 6/3825; G02B 6/387

(57) ABSTRACT

This optical module provided by the present disclosure includes an optical component, an optical fiber adapter, an optical cable plug, an anti-unlocking component and an unlocking component. The optical cable plug includes a base and a sleeve. The base is inserted into the optical fiber adapter, and a limiting groove is formed on it; the sleeve is slidably sleeved on the base; the optical cable plug and the optical fiber adapter can be locked or disassembled by moving the sleeve. The anti-unlocking component is arranged on the optical cable plug and is formed therein with a locking mechanism, and the locking mechanism is embedded in the limiting groove to lock and limit the sleeve.

### CROSS-REFERENCE TO RELATED APPLICATIONS

This application is a continuation in part of PCT/CN2023/120024, filed on Sep. 20, 2023, which claims priorities to Chinese Application No. 202310796445.4, filed on Jun. 30, 2023, with the China National Intellectual Property Administration (CNIPA); Chinese Application No. 202321704612.X, filed on Jun. 30, 2023, with the CNIPA; Chinese Application No. 202310796688.8, filed on Jun. 30, 2023, with the CNIPA; Chinese Application No. 202310796703.9, filed on Jun. 30, 2023, with the CNIPA; and Chinese Application No. 202310796764.5, filed on Jun. 30, 2023, with the CNIPA, the entire disclosures of which are incorporated herein by reference.

### FIELD

This disclosure relates to the technical field of optical fiber communication technology, particularly to an optical module.

### BACKGROUND

With the development of new services and application models such as cloud computing, mobile Internet, and video, the development and progress of optical communication technology has become increasingly important. In optical communication technology, the optical module is a tool for realizing the mutual conversion of optical and electrical signals. It is one of the key components in optical communication equipment and is at the core of optical communication.

### SUMMARY

An optical module provided according to the present disclosure includes an optical component, an optical fiber adapter, an optical cable plug, an anti-unlocking component and an unlocking component. The optical fiber adapter is connected to the optical component through an optical fiber ribbon. One end of the optical cable plug is inserted into the optical fiber adapter, wherein the optical cable plug includes a base and a sleeve. The base is inserted into the optical fiber adapter, and a limiting groove is formed on the base; the sleeve is sleeved on the base, and the sleeve is slidably connected to the base. The optical cable plug and the optical fiber adapter can be locked or disassembled through moving of the sleeve. The anti-unlocking component is arranged on the optical cable plug, and a locking mechanism is formed inside the anti-unlocking component, and the locking mechanism is embedded in the limiting groove to lock and limit the sleeve.

### BRIEF DESCRIPTION OF THE DRAWINGS

In order to illustrate technical solutions disclosed in this disclosure more clearly, a brief description on the accompanying drawings required in some embodiments of this disclosure will be given below. It is obvious that the accompanying drawings described below are only those of some embodiments of this disclosure, and for those skilled in the art, other accompanying drawings may also be obtained based on these drawings. In addition, the accompanying drawings described below may be regarded as schematic diagrams and are not intended to limit actual size of the relevant products, actual process of the relevant methods, actual timing of signals or the like involved in the disclosed embodiments.

FIG. 1 is a partial structural diagram of an optical communication system provided according to some embodiments of this disclosure;

FIG. 2 is a partial structural diagram of a host computer provided according to some embodiments of this disclosure;

FIG. 3 is a structural diagram of an optical module provided according to some embodiments of the present disclosure;

FIG. 4 is an exploded diagram of an optical module provided according to some embodiments of this disclosure;

FIG. 5 is a partial structural diagram of an optical module provided according to some embodiments of the present disclosure;

FIG. 6 is a partial exploded view of an optical module provided according to some embodiments of the present disclosure;

FIG. 7 is a schematic view of an optical cable plug and an optical fiber adapter of an optical module according to some embodiments of the present disclosure in a disassembled state;

FIG. 8 is a structural diagram of an optical cable plug of an optical module according to some embodiments of the present disclosure;

FIG. 9 is a structural diagram of a claw member of an optical module according to some embodiments of the present disclosure;

FIG. 10 is a structural diagram of a claw member of an optical module provided in accordance with some embodiments of the present disclosure from another perspective;

FIG. 11 is a schematic diagram of an optical cable plug and an optical fiber adapter of an optical module according to some embodiments of the present disclosure in an assembled state;

FIG. 12 is a sectional view of an optical cable plug and an optical fiber adapter of an optical module according to some embodiments of the present disclosure in an assembled state;

FIG. 13 is an exploded view of an optical cable plug and a protective cover of an optical module according to some embodiments of the present disclosure;

FIG. 14 is a first structural diagram of a first protective cover of an optical module according to some embodiments of the present disclosure;

FIG. 15 is a second structural diagram of a first protective cover in an optical module provided according to some embodiments of the present disclosure;

FIG. 16 is a third structural diagram of a first protective cover in an optical module according to some embodiments of the present disclosure;

FIG. 17 a fourth structural diagram of a first protective cover in an optical module according to some embodiments of the present disclosure;

FIG. 18 is a structural diagram of a locking boss in an optical module according to some embodiments of the present disclosure;

FIG. 19 is a fifth structural diagram of a first protective cover in an optical module according to some embodiments of the present disclosure;

FIG. 20 is a sixth structural diagram of a first protective cover in an optical module according to some embodiments of the present disclosure;

FIG. 21 is a seventh structural diagram of a first protective cover in an optical module according to some embodiments of the present disclosure;

FIG. 22 is an eighth structural diagram of a first protective cover in an optical module according to some embodiments of the present disclosure;

FIG. 23 is a sectional view of an optical cable plug and a protective cover in an optical module according to some embodiments of the present disclosure in an assembled state;

FIG. 24 is a partial structural diagram of an upper shell part of an optical module according to some embodiments of the present disclosure;

FIG. 25 is a partial diagram of an optical cable plug, an upper shell part and an optical fiber adapter in an optical module according to some embodiments of the present disclosure, in an assembled state;

FIG. 26 is a sectional view of an optical cable plug, an upper shell part and an optical fiber adapter in an optical module according to some embodiments of the present disclosure in an assembled state;

FIG. 27 is a partial sectional view of an optical module provided according to some embodiments of the present disclosure;

FIG. 28A is a structural diagram of another optical cable plug according to some embodiments;

FIG. 28B is a sectional view of another optical cable plug according to some embodiments;

FIG. 28c is a first sectional view of another optical module according to some embodiments;

FIG. 29A is a diagram showing a connection state of another optical cable plug and an anti-unlocking component according to some embodiments;

FIG. 29B is a sectional view of another optical cable plug and an anti-unlocking component according to some embodiments;

FIG. 29C is a second sectional view of another optical module according to some embodiments;

FIG. 29D is a sectional view of another optical cable plug and an optical fiber adapter according to some embodiments;

FIG. 30A is an exploded schematic diagram of another optical cable plug and an anti-unlocking component according to some embodiments;

FIG. 30B is a structural diagram of an anti-unlocking component according to some embodiments;

FIG. 30C is an exploded view of an anti-unlocking component according to some embodiments;

FIG. 31A is a first structural diagram of a connecting member according to some embodiments;

FIG. 31B is a second structural diagram of a connecting member according to some embodiments;

FIG. 31C is a third structural diagram of a connecting member according to some embodiments;

FIG. 31D is a fourth structural diagram of a connecting member according to some embodiments;

FIG. 31E is a sectional view of a connecting member according to some embodiments;

FIG. 32 is a sectional view of an anti-unlocking component according to some embodiments;

FIG. 33A is a first structural diagram of another connecting member according to some embodiments;

FIG. 33B is a second structural diagram of another connecting member according to some embodiments;

FIG. 33C is a third structural diagram of another connecting member according to some embodiments;

FIG. 33D is a structural diagram of another connecting member according to some embodiments;

FIG. 34A is an exploded view of yet another anti-unlocking component according to some embodiments;

FIG. 34B is an exploded view of another anti-unlocking component according to some embodiments;

FIG. 35A is a structural diagram of another optical module according to some embodiments;

FIG. 35B is an exploded view of another optical module according to some embodiments;

FIG. 36 is a structural diagram of an unlocking component in an optical module according to some embodiments of the present disclosure;

FIG. 37 is an exploded view of an unlocking component in an optical module according to some embodiments of the present disclosure;

FIG. 38 is a diagram of an unlocking component in an optical module according to some embodiments of the present disclosure in an assembled and rotated state;

FIG. 39 is a diagram of a circuit board and a shielding component in an optical module according to some embodiments of the present disclosure in an assembled state;

FIG. 40 is a schematic view of a circuit board and a shielding component of an optical module according to some embodiments of the present disclosure;

FIG. 41 is a structural diagram of a circuit board of an optical module according to some embodiments of the present disclosure;

FIG. 42 is a side view of a circuit board of an optical module according to some embodiments of the present disclosure;

FIG. 43 is a structural diagram of a shielding cover-bracket of an optical module according to some embodiments of the present disclosure;

FIG. 44 is a diagram of a circuit board and a shielding bracket of an optical module according to some embodiments of the present disclosure in an assembled state;

FIG. 45 is a diagram of a circuit board and a shielding bracket of an optical module provided in accordance with some embodiments of the present disclosure in an assembled state, which is shown from another perspective;

FIG. 46 is a structural diagram of a shielding cover of an optical module according to some embodiments of the present disclosure;

FIG. 47 is a diagram of a circuit board and a shielding component of an optical module provided according to some embodiments of the present disclosure in an assembled state, which is shown at another angle;

FIG. 48 is a sectional view of a circuit board and a shielding component of an optical module according to some embodiments of the present disclosure in an assembled state;

FIG. 49 is a diagram of a circuit board, a shielding component and a lower shell part of an optical module according to some embodiments of the present disclosure in an assembled state; and

FIG. 50 is a sectional view of an optical module provided according to some embodiments of the present disclosure.

### DETAILED DESCRIPTION

In the optical communication technology, it is generally necessary to load information onto light and use the propagation of light to achieve information transmission, so as establish information transmission between information processing devices. In this regard, the light loaded with information is namely an optical signal. The optical signal is propagated in the information transmission devices, which may reduce loss of optical power and achieve high-speed, long-distance, and low-cost information transmission. The information that may be processed by the information processing device is an electrical signal. The information processing device generally includes an optical network unit (ONU), a gateway, a router, a switch, a mobile phone, a computer, a server, a tablet, a television and the like, and the information transmission device typically includes an optical fiber, a waveguide and the like.

Conversion of optical and electrical signals between the information processing device and the information transmission device may be achieved through the optical module. For example, an optical fiber may be connected to an optical signal input and/or output end of an optical module, and an optical network unit may be connected to an electrical signal input and/or output end of the optical module; a first optical signal from the optical fiber is transmitted to the optical module, which converts the first optical signal into a first electrical signal, and then transmits the first electrical signal to the optical network unit; a second electrical signal from the optical network unit is transmitted into the optical module, which converts the second electrical signal into a second optical signal, and then transmits the second optical signal to the optical fiber. Since information transmission between multiple information processing devices may be made via an electrical signal, at least one of the information processing devices needs to be directly connected to the optical module, and it is unnecessary for all of the information processing devices to be directly connected to the optical module. The information processing device directly connected to the optical module is called as a host computer of the optical module. In addition, the optical signal input end or the optical signal output end of the optical module may be called as an optical port, and the electrical signal input end or the electrical signal output end of the optical module may be called as an electrical port.

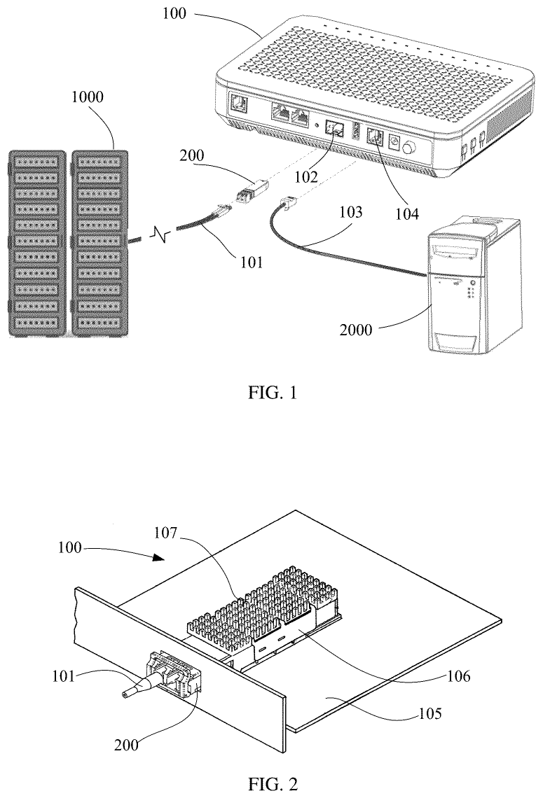

FIG. 1 is a partial structural diagram of an optical communication system provided according to some embodiments of the present disclosure. As shown in FIG. 1, the optical communication system mainly includes a remote information processing device 1000, a local information processing device 2000, a host computer 100, an optical module 200, an external optical fiber 101, and a network cable 103.

One end of the external optical fiber 101 extends towards the remote information processing device 1000, while the other end thereof is coupled to the optical module 200 through the optical port of the optical module 200. An optical signal may undergo a total reflection in the optical fiber 101, and propagation of the optical signal in a total reflection direction can almost maintain the original optical power. The optical signal undergoes multiple total reflections in the optical fiber 101, such that the optical signal from the remote information processing device 1000 is transmitted into the optical module 200, or the optical signal from the optical module 200 is transmitted to the remote information processing device 1000, thereby achieving long-distance information transmission with low power loss.

The optical communication system may include one or more external optical fiber 101. The external optical fiber 101 may be detachably connected or fixedly connected to the optical module 200. The host computer 100 is configured to provide data signals to the optical module 200, receive data signals from the optical module 200, or monitor or control the working state of the optical module 200.

The host computer 100 includes a substantially rectangular housing and an optical module interface 102 disposed on the housing. The optical module interface 102 is configured to connect to the optical module 200 such that a unidirectional or bidirectional electrical signal connection is established between the host computer 100 and the optical module 200.

The host computer 100 includes an external electrical interface which may be coupled to the electrical signal network. For example, the external electrical interface includes a Universal Serial Bus (USB) interface or a network cable interface 104, and the network cable interface 104 is configured to be coupled by the network cable 103, thereby establishing a unidirectional/bidirectional electrical signal connection between the host computer 100 and the network cable 103. One end of the network cable 103 is connected to the local information processing device 2000, and the other end thereof is connected to the host computer 100, so as to establish an electrical signal connection between the local information processing device 2000 and the host computer 100 through the network cable 103. For example, a third electrical signal emitted by the local information processing device 2000 is transmitted to the host computer 100 through the network cable 103; the host computer 100 generates a second electrical signal based on the third electrical signal; the second electrical signal from the host computer 100 is transmitted to the optical module 200; the optical module 200 converts the second electrical signal into a second optical signal, and transmits the second optical signal to the optical fiber 101, and the second optical signal is transmitted to the remote information processing device 1000 through the optical fiber 101. For example, a first optical signal from the remote information processing device 1000 is propagated through the optical fiber 101; the first optical signal from the optical fiber 101 is transmitted into the optical module 200; the optical module 200 converts the first optical signal into a first electrical signal, and transmits the first electrical signal to the host computer 100; the host computer generates a fourth electrical signal based on the first electrical signal, and transmits the fourth electrical signal to the local information processing device 2000. It is noted that the optical module is a tool for achieving the conversion between optical and electrical signals, and during the conversion between optical and electrical signals as described above, the information is not changed, but methods for encoding and decoding the information may be changed.

The host computer 100 includes not only an optical network unit but also an optical line terminal (OLT), an optical network terminal (ONT), or a data center server or the like.

FIG. 2 is a partial structural diagram of a host computer according to some embodiments. In order to illustrate a connection relationship between the optical module 200 and the host computer 100 clearly, FIG. 2 only shows the structure of the host computer 100 related to the optical module 200. As shown in FIG. 2, the host computer 100 further includes a PCB circuit board 105 disposed within the housing, a cage 106 disposed on a surface of the PCB circuit board 105, a radiator 107 disposed on the cage 106, and an electrical connector disposed inside the cage 106. The electrical connector is configured to couple with the electrical port of the optical module 200. The radiator 107 has a raised structure, such as a fin, that increases a heat dissipation area.

The optical module 200 is inserted into the cage 106 of the host computer 100 and then is secured by the cage 106. Thus, heat generated by the optical module 200 is conducted to the cage 106, and then dissipated via the radiator 107. After the optical module 200 is inserted into the cage 106, an electrical port of the optical module 200 is connected to the electrical connector inside the cage 106 such that a bidirectional electrical signal connection is established between the optical module 200 and the host computer 100. In addition, the optical port of the optical module 200 is connected to the external optical fiber 101, such that the optical module 200 establishes a bidirectional optical signal connection with the external optical fiber 101.

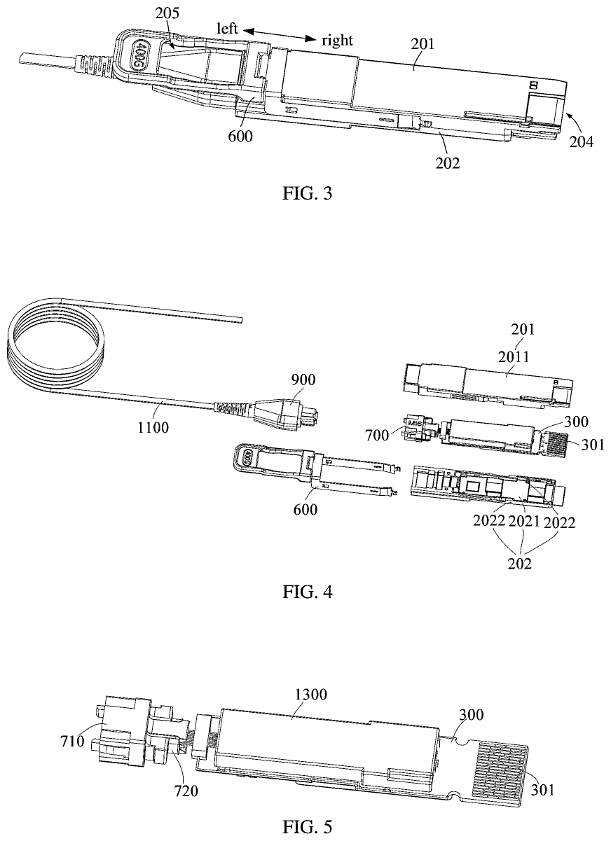

FIG. 3 is a structural diagram of an optical module according to some embodiments of this disclosure, and FIG. 4 is an exploded diagram of an optical module according to some embodiments. As shown in FIG. 3 and FIG. 4, the optical module 200 includes a shell, and a circuit board 300, an optical component and an optical fiber adapter 700 that are disposed within the shell. The optical fiber adapter 700 may be connected to the optical component through an optical fiber ribbon.

The shell may include an upper shell part 201 and a lower shell part 202. The upper shell part 201 is covered on the lower shell part 202 to form the aforementioned shell having two openings 204 and 205. An outer contour of the shell is generally in a cuboid shape.

In some embodiments, the lower shell part 202 includes a bottom plate 2021 and two lower side plates 2022 located at opposite sides of the bottom plate 2021 and disposed perpendicular to the bottom plate 2021, and the upper shell part 201 includes an upper cover plate 2011 which is covered on the two lower side plates 2022 of the low shell part 202 so as to form the above-mentioned shell.

In some embodiments, the lower shell part 202 includes a bottom plate 2021 and two lower side plates 2022 located on opposite sides of the bottom plate 2021 and disposed perpendicular to the bottom plate 2021; the upper shell part 201 includes a upper cover plate 2011 and two upper side plates located on opposite sides of the upper cover plate 2011 and disposed perpendicular to the upper cover plate 2011, and the two upper side plates are combined with the two lower side plates 2022 such that the upper shell part 201 is covered on the lower shell part 202.

A direction along a connecting line between the two openings 204 and 205 may be consistent with a length direction of the optical module 200 or inconsistent with the length direction of the optical module 200. For example, the opening 204 is located at an end of the optical module 200 (right end in FIG. 3), and the opening 205 is also located at an end of the optical module 200 (left end in FIG. 3). Alternatively, the opening 204 is located at an end of the optical module 200, while the opening 205 is located at a side of the optical module 200. The opening 204 is an electrical port, and a golden finger 301 of the circuit board 300 extends out of the electrical port and is inserted into the electrical connector of the host computer. The opening 205 is an optical port configured to be coupled by the external optical fiber 101 such that the external optical fiber 101 is connected with the optical component of the optical module 200.

The assembling way in which the upper shell part 201 is combined with the lower shell part 202 facilitates mounting the circuit board 300, the optical component, the optical fiber adapter 700 or the like into the above-mentioned shell, such that these components are encapsulated and protected by the upper shell part 201 and the lower shell part 202. In addition, when assembling the circuit board 300, the optical component, the optical fiber adapter 700 or the like, it is easier to deploy positioning elements, heat dissipation elements, and electromagnetic shielding elements of these components with the assembling way in which the upper shell part 201 is combined with the lower shell part 202, which facilitates automate production implementation.

In some embodiments, the upper shell part 201 and the lower shell part 202 are made of metal material(s), which facilitates to achieve electromagnetic shielding and heat dissipation.

In some embodiments, the optical module 200 further includes an unlocking component 600 located outside the shell thereof. The unlocking component 600 is configured to achieve a fixed connection between the optical module 200 and the host computer 100 or to release the fixed connection between the optical module 200 and the host computer 100.

For example, the unlocking component 600 is located outside the two lower side plates 2022 of the lower shell part 202, and includes a snapping part (or an engaging part) that matches with the cage 106 of the host computer 100. When the optical module 200 is inserted into the cage 106, the snapping part of the unlocking component 600 secures the optical module 200 within the cage 106. As the unlocking component 600 is pulled, the snapping part of the unlocking component 600 moves accordingly, and thus the connection relationship between the snapping part and the host computer is changed, thereby releasing the fixed connection between the optical module 200 and the host computer, such that the optical module 200 can be drawn out of the cage 106.

The circuit board 300 includes circuit wiring, electronic elements, chips, and so on. The electronic elements and chips are connected together via the circuit wiring according to a circuit design so as to achieve various functions such as power supply, electrical signal transmission, and grounding. For example, the electronic element may include a capacitor, a resistor, a transistor, and a Metal-Oxide-Semiconductor Field-Effect Transistor (MOSFET). For example, the chip may include a microcontroller unit (MCU), a laser driver chip, a transimpedance amplifier (TIA), a limiting amplifier (LA), a Clock and Data Recovery (CDR) chip, a power management chip, and a digital signal processing (DSP) chip.

The circuit board 300 is generally a rigid circuit board. Also, the rigid circuit board may achieve a carrying function due to its relatively hard material. For example, the rigid circuit board may steadily carry the above-mentioned electronic elements and chips thereon. Furthermore, the rigid circuit board may be easily inserted into the electrical connector inside the cage 106 of the host computer 100.

The circuit board 300 further includes a golden finger 301 formed on a surface of an end thereof, which is composed of multiple independent pins. The circuit board 300 is inserted into the cage 106 and is conductively connected to the electrical connector inside the cage 106 via the golden finger 301. The golden finger 301 may be disposed only on the surface of one side of the circuit board 300 (e.g., an upper surface shown in FIG. 4), or on surfaces of upper and lower sides of the circuit board 300 to provide a larger number of pins, so as to adapt to occasions where a large number of pins are required. The golden finger 301 is configured to establish an electrical connection with the host computer to achieve power supply, grounding, Inter-Integrated Circuit (I2C) signal transmission, data signal transmission or the like. Of course, it is possible to use a flexible circuit board in some optical modules. The flexible circuit board is generally used in cooperation with the rigid circuit board to serve as a supplement to the rigid circuit board.

The optical component is directly disposed on the circuit board 300, and is located at a side of the circuit board 300 away from the golden finger 301.

In some embodiments, the optical component includes at least one of an optical emission component and an optical reception component, and at least one of the optical emission component and the optical reception component can be directly disposed on the circuit board 300. For example, at least one of the optical emission component and the optical reception component can be disposed on the surface of the circuit board 300 or on the side of the circuit board 300.

In some embodiments, the optical component is physically separated from the circuit board 300 and then electrically connected to the circuit board 300 through a corresponding flexible circuit board or electrical connector.

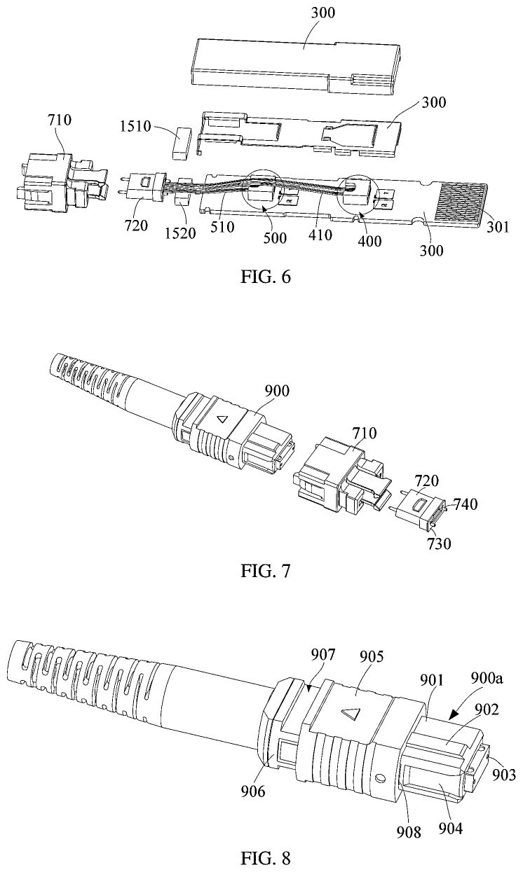

FIG. 5 is a partial structural diagram of an optical module provided according to some embodiments of the present disclosure, and FIG. 6 is a partial exploded diagram of an optical module provided according to some embodiments of the present disclosure. As shown in FIG. 5 and FIG. 6, the optical component includes a first optical component 400 and a second optical component 500. The first optical component 400 and the second optical component 500 may have emitting and receiving functions to realize two groups of optical emission and two groups of optical reception. However, the present disclosure is not limited to this. In some embodiments, the first optical component 400 and the second optical component 500 have one of the optical emission function and optical reception function.

In some embodiments, both the first optical component 400 and the second optical component 500 have both optical emission and optical reception functions, in this case, a light beam emitted by the first optical component 400 is transmitted to the external optical fiber 101 via the first optical fiber ribbon 410 and the optical fiber adapter 700 to achieve the emission of one group of lights; a light beam emitted by the second optical component 500 is transmitted to the external optical fiber 101 via the second optical fiber ribbon 510 and the optical fiber adapter 700 to achieve the emission of another group of lights; a received light beam transmitted by the external optical fiber 101 is transmitted to the first optical component 400 via the optical fiber adapter 700 and the first optical fiber ribbon 410 to achieve reception of one group of lights; a received light beam transmitted by the external optical fiber 101 is transmitted to the second optical component 500 via the optical fiber adapter 700 and the second optical fiber ribbon 510 to achieve reception of another group of lights, thereby achieving emission of two groups of light and reception of two groups of light of the optical module 200.

In some embodiments, an optical fiber plug is disposed at one end of the external optical fiber 101 that is inserted into the optical fiber adapter 700, and the optical fiber plug is inserted into the optical fiber adapter 700 when in use, such that an optical signal transmitted by the optical fiber ribbon is coupled to the external optical fiber through the optical fiber adapter 700, and a received optical signal transmitted by the external optical fiber is transmitted to the first optical component 400 and the second optical component 500 through the optical fiber adapter 700.

In some embodiments, not only the external optical fiber 101 but also an active optical cable (AOC) may be inserted into the optical port of the optical module 200. The AOC, as the main transmission medium for high-performance computing and data centers in the big data era, has such advantages as high bandwidth, anti-electromagnetic interference, long transmission distance, low power consumption, small cable size, easy use and compliance with dense wiring in computer rooms. When an optical cable is inserted into the optical port of the optical module 200, the optical cable and the optical module 200 constitute an AOC optical module.

In order that the external optical fiber 101 or the AOC optical cable can be inserted into the optical port of the optical module 200, the optical module 200 needs to have two optical port structures, respectively. Therefore, the production of the optical module 200 requires two production lines, and the two production lines require two sets of molds, resulting in high production costs of the optical module and low switching efficiency of the two kinds of optical modules.

In order to facilitate switching the optical port of the optical module such that the external optical fiber 101 or the AOC optical cable may be inserted into the optical port, the optical module provided according to the embodiments of the present disclosure can function as an optical transceiver module as well as an AOC optical module. It is only necessary to generate an optical transceiver module TRX, and when needed, the non-AOC optical module may be converted into an AOC optical module by fixing the optical cable plug with a set of anti-disassembly structures, thereby realizing mutual switching between the non-AOC optical module and the AOC optical module.

FIG. 7 is a diagram of an optical cable plug and an optical fiber adapter of an optical module according to some embodiments of the present disclosure in a disassembled state. As shown in FIG. 7, the optical fiber adapter 700 includes a claw member 710 and an optical fiber plug 720. The claw member 710 is formed therein with a through hole. The optical fiber plug 720 is inserted into one end of the through hole. The optical fiber plug 720 is connected to the first optical component 400 and the second optical component 500 through an optical fiber ribbon. The external optical fiber 101 is inserted into the other end of the through hole. The external optical fiber 101 is coupled and connected to the optical fiber plug 720 to achieve coupling between the optical fiber adapter 700 and the external optical fiber 101.

When the external optical fiber 101 is disassembled from the optical fiber adapter 700, an active optical cable 1100 may be inserted into the other end of the through hole via an optical cable plug 900. The active optical cable 1100 is coupled to the optical fiber plug 720 through the claw member 710 to achieve coupling between the active optical cable 1100 and the optical fiber adapter 700, and thus the non-AOC optical module is converted into an AOC optical module.

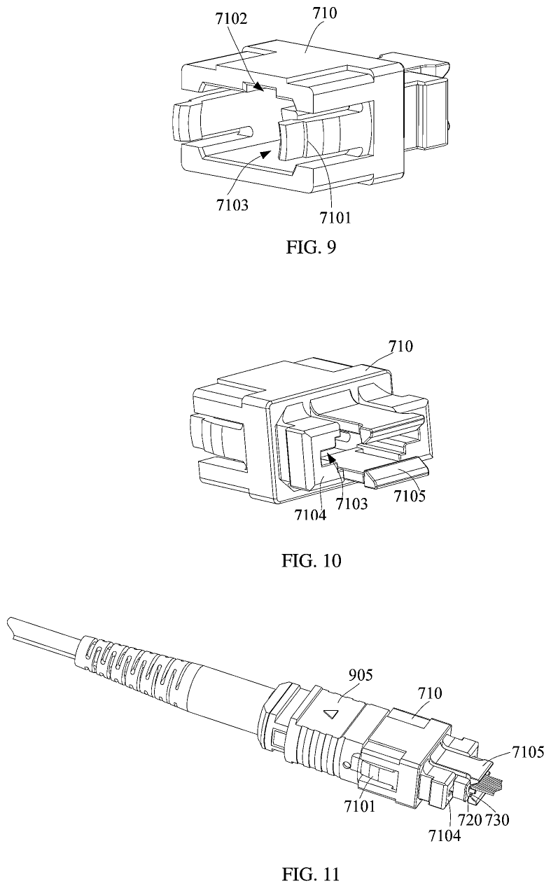

FIG. 8 is a structural diagram of an optical cable plug of an optical module according to some embodiments of the present disclosure, FIG. 9 is a structural diagram of a claw member of an optical module according to some embodiments of the present disclosure, and FIG. 10 is a structural diagram of a claw member of an optical module according to some embodiments of the present disclosure, which is shown from another perspective. As shown in FIG. 8, FIG. 9 and FIG. 10, the optical cable plug 900 includes a base 900a and a sleeve 905, one end of the base 900a is inserted into the optical fiber adapter 700, the sleeve 905 is sleeved on the base 900a and is slidably connected to the base 900a, and by moving the sleeve 905, the optical cable plug 900 and the optical fiber adapter 700 can be locked, or the optical cable plug 900 and the optical fiber adapter 700 can be disassembled. For example, the base 900a includes a plug-in portion 901 and a connecting portion 906, opposite ends of the connecting portion 906 are fixedly connected to the plug-in portion 901 and the active optical cable 1100, respectively, and the plug-in portion 901 can be inserted into the optical port of the optical module so as to convert the optical module into an AOC optical module.

The sleeve 905 is sleeved on the connecting portion 906, and the sleeve 905 is slidable left and right on the connecting portion 906. When the plug-in portion 901 is inserted to the right into the optical fiber adapter 700, the sleeve 905 is located on the left side of the connecting portion 906 to enable the plug-in portion 901 to be engaged with the optical fiber adapter 700. Then the sleeve 905 is moved to the right to lock the optical cable plug 900 and the optical fiber adapter 700 through the sleeve 905 to prevent the optical cable plug 900 from being detached.

In some embodiments, when an operator unplugs the optical cable 1100, the operator presses the sleeve 905 and moves it leftward, and then unplugs the plug-in portion 901 from the optical fiber adapter 700 to disconnect the optical cable plug 900 from the optical fiber adapter 700.

In some embodiments, a sliding arrow may be provided on a top surface of the sleeve 905, and the operator can identify a forward direction of the optical cable plug 900 according to the sliding arrow. When the optical cable plug 900 is inserted into the optical fiber adapter 700 in the forward direction, the sliding arrow on the sleeve 905 faces the upper shell part 201, thereby preventing the optical cable plug 900 from being inserted into the optical fiber adapter 700 in the reverse direction, ensuring the optical coupling effect between the optical cable plug 900 and the optical fiber adapter 700.

In some embodiments, a protrusion 902 is formed on the top surface of the plug-in portion 901, and the protrusion 902 extends from the right side surface of the plug-in portion 901 to the right side surface of the connecting portion 906. The protrusion 902 is arranged along the left-right direction, and there are gaps between two opposite side surfaces of the protrusion 902 and two opposite side surfaces of the plug-in portion 901, that is, the protrusion 902 is not located on either side edge of the plug-in portion 901, so as to ensure the installation stability of the optical fiber plug 900.

First engaging grooves 904 are formed on opposite side surfaces (the two side surfaces connected to the top surface) of the plug-in portion 901. The first engaging groove 904 extends from the right side surface of the plug-in portion 901 to the right side surface of the connecting portion 906. The first engaging groove 904 is recessed relative to the side surface of the plug-in portion 901, and the first engaging groove 904 has an opening on the right side thereof to facilitate the insertion of the engaging part of the optical fiber adapter 700 into the first engaging groove 904, thereby realizing the coupling connection between the optical cable plug 900 and the optical fiber adapter 700.

In some embodiments, second engaging grooves 908 are provided on opposite side surfaces of the connecting portion 906, and the second engaging grooves 908 are located on the right side of the connecting portion 906. The second engaging groove 908 may be communicated to the first engaging groove 904. When the sleeve 905 is located on the left side of the connecting portion 906, the second engaging groove 908 is exposed, and when the sleeve 905 is slid to the right side of the connecting portion 906, the second engaging groove 908 is located inside the sleeve 905. When the plug-in portion 901 is inserted into the optical fiber adapter 700, the sleeve 905 is slid to the left side, and the engaging parts of the optical fiber adapter 700 can be inserted into the second engaging grooves 908 via the first engaging grooves 904; then the sleeve 905 is slid to the right, such that the sleeve 905 clamps the engaging parts of the optical fiber adapter 700, so as to achieve the locking and fixing of the optical cable plug 900 and the optical fiber adapter 700.

In some embodiments, the second engaging groove 908 and the first engaging groove 904 may not be communicated with each other. When the plug-in portion 901 is inserted into the optical fiber adapter 700, the sleeve 905 is slid to the left, and left ends of the engaging parts of the optical fiber adapter 700 are engaged into the second engaging grooves 908, and middle portions of the engaging parts are engaged into the first engaging grooves 904, so as to clamp the optical cable plug 900 and the optical fiber adapter 700 through the engaging parts.

Referring to FIG. 9, the claw member 710 is formed therein with a through hole 7103, and slots are formed on two opposite sides of the claw member 710, one end of each slot is provided with an opening, and a first engaging part 7101 is provided in the slot. One end of the first engaging part 7101 is fixedly connected to the claw member 710, such that the first engaging part 7101 can be rotated (or turned) at a preset angle in the slot, so that the first engaging part 7101 can be pushed outward or clamped inward. Exemplarily, the first engaging part 7101 may be an elastic engaging part or be a non-elastic engaging part, which is not limited in the present disclosure.

An inner wall of the top portion of the claw member 710 is formed thereon with a guide groove 7102. The guide groove 7102 extends from the left side to the right side of the claw member 710. The guide groove 7102 is configured to guide the optical cable plug 900 to be inserted into the through hole 7103, that is, when the plug-in portion 901 is inserted into the through hole 7103 of the claw member 710, the protrusion 902 on the plug-in portion 901 is inserted into the claw member 710 along the guide groove 7102, and the optical cable plug 900 is fixedly connected through the first engaging parts 7101 on the claw member 710, so as to realize the fixed connection between the optical cable plug 900 and the claw member 710.

In some embodiments, when the plug-in portion 901 is inserted into the through hole 7103, the first engaging part 7101 is engaged into the first engaging groove 904 and the second engaging groove 908, and the optical cable plug 900 inserted into the claw member 710 is fixedly connected through the first engaging parts 7101; then, the sleeve 905 may be slid to the right, and the first engaging parts 7101 are clamped by the sleeve 905, so as to fixedly connect the optical cable plug 900 and the claw member 710 through the first engaging parts 7101.

When pulling the optical cable plug 900 from the optical fiber adapter 700, the operator may slide the sleeve 905 to the left, and then pry or turn the first engaging part 7101 outward to move the optical cable plug 900 to the left, so as to separate the optical cable plug 900 from the optical fiber adapter 700.

In some embodiments, considering that the claw member 710 is an elastic member, if the operator makes an error and inserts the optical cable plug 900 into the claw member 710 in the reverse direction (rotated 360 degrees), the optical cable plug 900 may also expand the claw member 710 and be successfully inserted into the claw member 710, however, under this circumstance, it is impossible for the optical cable plug 900 to couple with the optical fiber plug 720 in the claw member 710, which thereby affects the optical coupling effect.

In order to prevent the optical cable plug 900 from being inserted into the claw member 710 in reverse, the bottom surface of the plug-in portion 901 may be formed thereon with a guide groove, and a guide post may be formed on the inner wall of the bottom portion of the claw member 710. When the optical cable plug 900 is inserted into the claw member 710 in the forward direction, the protrusion 902 on the optical cable plug 900 is inserted into the guide groove 7102 in the claw member 710, and the guide post in the claw member 710 is inserted into the guide groove on the optical cable plug 900; if the optical cable plug 900 is reversed (such as flipped 360 degrees), the protrusion 902 on the optical cable plug 900 would collide with the guide post in the claw member 710, and the guide post blocks the optical cable plug 900 from be moved rightward, so that the optical cable plug 900 cannot be inserted into the plug 710, warning the operator that the insertion operation is reversed, and reminding the operator to correctly insert the optical cable plug 900.

In some embodiments, a limiting surface is formed in the through hole 7103 of the claw member 710, and a diameter of the part of the through hole passing through the limiting surface is smaller than a diameter of the part of the through hole on the left side of the claw member 710. In this way, when the optical cable plug 900 is inserted into the through hole 7103 of the claw member 710, the plug end face of the plug-in part 901 abuts against the limiting surface to limit and fix the optical cable plug 900.

In some embodiments, a socket 903 is formed on the right side surface of the plug-in portion 901, and the socket 903 extends from the right side surface of the plug-in portion 901 toward the left side. When the optical cable plug 900 is inserted into the optical fiber adapter 700, the pin in the optical fiber adapter 700 is inserted into the socket 903 to position the optical cable plug 900 and the optical fiber adapter 700.

Referring to FIG. 7, to facilitate the coupling connection of the optical cable plug 900 with the optical fiber plug 720 when the optical fiber plug 720 is inserted into the claw member 710, the optical fiber adapter 700 further includes a fixing member 730 and a pin 740. One end of the fixing member 730 is in contact with an end surface of the optical fiber plug 720, and the other end of the fixing member 730 is fixedly engaged with the claw member 710. In this way, the optical fiber plug 720 is fixed in the claw member 710 by the fixing member 730.

As shown in FIG. 10, one end of the claw member 710 facing away from the optical cable plug 900 is formed with a second engaging part 7105, and one end of the second engaging part 7105 is fixedly connected to the claw member 710. Two second engaging parts 7105 are formed on the claw member 710, and the two second engaging parts 7105 are respectively fixedly connected to a top portion and a bottom portion of the claw member 710, that is, the two second engaging parts 7105 are arranged in the up-down direction. Exemplarily, the second engaging part 7105 may be an elastic engaging part or have other forms, which is not limited in the present disclosure.

The second engaging part 7105 can be rotated or turned within a preset angle range, so that the second engaging part 7105 can be clamped inward to fix the optical fiber plug 720, and can also be bent outward to remove the optical fiber plug 720.

In some embodiments, the end of the claw member 710 facing away from the optical cable plug 900 has a first side surface 7104, and the through hole 7103 passes through the first side surface 7104. In this way, the optical fiber plug 720 can be inserted into the claw member 710 through the through hole 7103, and the optical fiber plug 720 can be limited by the first side surface 7104.

In some embodiments, the optical fiber plug 720 includes a core and a fixing part, wherein an outer wall of the fixing part protrudes relative to an outer wall of the core, that is, a width of the fixing part in the up-down direction is greater than a width of the core in the up-down direction, and a length of the fixing part in the front-to-back direction is greater than a length of the core in the front-to-back direction.

When the optical fiber plug 720 is inserted into the through hole 7103 of the claw member 710, the core extends into the through hole 7103, and a second side surface where the core is connected to the fixing part abuts against the first side surface 7104, so as to limit the optical fiber plug 720 through the first side surface 7104, such that the fixing part is located outside the through hole 7103.

In some embodiments, the second engaging part 7105 of the claw member 710 protrudes relative to the first side surface 7104, and when the core of the optical fiber plug 720 is inserted into the through hole 7103 of the claw member 710, the fixing part of the optical fiber plug 720 is located in a gap between the second engaging part 7105 and the first side surface 7104.

The fixing part of the optical fiber plug 720 also includes a third side surface facing away from the core, and the third side surface contacts one end surface of the fixing member 730. When the core of the optical fiber plug 720 is inserted into the through hole 7103 of the claw member 710, the second side surface of the optical fiber plug 720 is abutted against the first side surface 7104 of the claw member 710, and the fixing member 730 is abutted on the third side surface of the optical fiber plug 720, and the second engaging part 7105 abuts against the end surface of the fixing member 730 to apply a force to the fixing member 730 and the optical fiber plug 720, such that the optical fiber plug 720 and the fixing member 730 are held in the claw member 710.

In some embodiments, an optical fiber socket is formed on the third side surface of the optical fiber plug 720, and a plurality of optical fiber holes are formed on the side surface where the core is inserted into the through hole 7103, and the plurality of optical fiber holes are communicated to the optical fiber socket, such that the optical fiber ribbon is inserted into the optical fiber plug 720 through the optical fiber socket, and each optical fiber of the optical fiber ribbon is placed in one optical fiber hole.

When the optical fiber is placed in the optical fiber hole, a light exiting surface of the optical fiber is located outside the optical fiber plug 720. Thus, when the optical fiber plug 720 and the optical cable plug 900 are connected in the claw member 710, the optical signal transmitted by the optical fiber is directly coupled to the optical cable plug 900.

In some embodiments, the optical fiber plug 720 may be an MT male connector, and the optical cable plug 900 may correspondingly be a MT female connector. After the pin 740 is fixedly connected to the optical fiber plug 720, the pin 740 protrudes from the optical fiber plug 720 toward the optical cable plug 900. In this way, when the optical cable plug 900 is inserted into the claw member 710, the protruding pin 740 is inserted into the socket 903 on the end face of the optical cable plug 900, so as to realize the positioning and connection between the optical fiber plug 720 and the optical cable plug 900 through the pin 740.

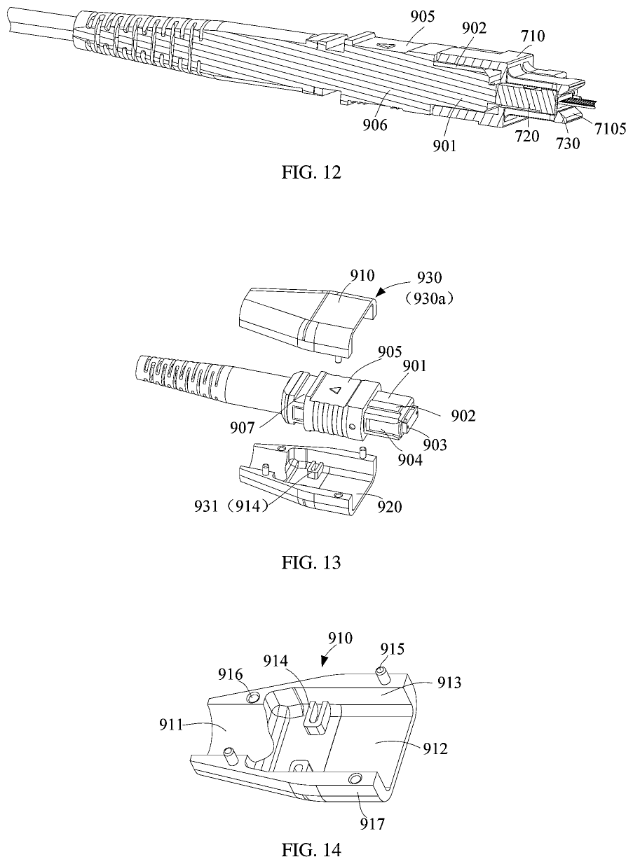

FIG. 11 is a diagram of an optical cable plug and an optical fiber adapter of an optical module according to some embodiments of the present disclosure in an assembled state, and FIG. 12 is a sectional view of an optical cable plug and an optical fiber adapter of an optical module according to some embodiments of the present disclosure in an assembled state. As shown in FIG. 11 and FIG. 12, when assembling the optical fiber adapter 700 and the optical cable plug 900, firstly, one side surface of the fixing member 730 is placed against the third side surface of the optical fiber plug 720, and then the pin 740 is inserted into a pin hole of the optical fiber plug 720 through the through hole in the fixing member 730, and the pin 740 is fixedly connected to the optical fiber plug 720 through the fixing member 730; then, the assembled optical fiber plug 720, the fixing member 730 and the pin 740 are inserted into the through hole 7103 of the claw member 710, such that the second side surface of the optical fiber plug 720 is in contact with the first side surface 7104 of the claw member 710, and the second engaging part 7105 abuts against the fixing member 730, thereby fixing the optical fiber plug 720 and the fixing member 730 in the claw member 710.

Then, the plug-in portion 901 of the optical cable plug 900 is inserted into the other end of the claw member 710, and the left end of the pin 740 is inserted into the socket 903 of the optical cable plug 900 until the right side surface of the plug-in portion 901 abuts against the limiting surface in the through hole 7103; and then the first engaging parts 7101 are engaged into the first engaging groove 904 and the second engaging groove 908, and the optical cable plug 900 inserted into the claw member 710 is clamped by the first engaging parts 7101; and then the sleeve 905 is slid to the right to clamp the first engaging parts 7101. In this way, the optical cable plug 900 is clamped in the claw member 710, and the coupling connection between the optical cable plug 900 and the optical fiber adapter 700 is realized.

In some embodiments, when locking the plug-in portion 901 and the claw member 710 by sliding the sleeve 905, the operator may accidentally touch the sleeve 905, causing the sleeve 905 to slide to the left, so that the optical cable plug 900 and the claw member 710 are easily to be separated, resulting in abnormal detachment of the optical cable plug 900.

FIG. 13 is an exploded view of an optical cable plug and a protective cover of an optical module provided according to some embodiments of the present disclosure, and FIG. 14 is a first structural diagram of a first protective cover of an optical module provided according to some embodiments of the present disclosure. As shown in FIG. 13 and FIG. 14, in order to prevent the abnormal separation of the optical cable plug 900, the optical module further includes an anti-unlocking component 930, which can be arranged on at least one of the base 900a and the sleeve 905. A locking mechanism 931 is formed inside the anti-unlocking component 930, and the locking mechanism 930 is to be embedded in the limiting groove 907 to lock and limit the sleeve 905. With the locking mechanism 931 stopping the sleeve 905, anti-disassembly function of the optical cable plug 900 is realized.

Referring to FIG. 13 and FIG. 14, the anti-unlocking component 930 includes a protective cover 930a, which is sleeved on the sleeve 905. For example, the protective cover 930a includes a first protective cover 910 and a second protective cover 920, the first protective cover 910 and the second protective cover 920 constitute a pair of protective covers which are engaged up and down, wherein the first protective cover 910 is covered on an upper side of the optical cable plug 900, and the second protective cover 920 is placed on a lower side of the optical cable plug 900, therefore, the first protective cover 910 and the second protective cover 920 are engaged and connected to each other to wrap the sleeve 905 of the optical cable plug 900. In this way, the optical cable plug 900 will not be abnormally separated due to accidentally touching the sleeve 905.

In some embodiments, the first protective cover 910 and the second protective cover 920 may be designed as an upper cover and a lower cover, and may be distinguished by using a designed logo, font, obvious mark, or asymmetric appearance, that is, the first protective cover 910 and the second protective cover 920 may have different structure; the first protective cover 910 and the second protective cover 920 may also have the same design, that is, the first protective cover 910 and the second protective cover 920 have the same structure, and they are designed as the same parts. In this way, the parts are simple, only one set of molds is needed, and the assembly is simple, there is no need to distinguish between the upper and lower covers, the assembly is more user-friendly, and costs related to the parts and the assembly are low.

Referring to FIG. 14, in some embodiments, the structures of the first protective cover 910 and the second protective cover 920 may be the same. The first protective cover 910 includes a cover plate, a first side plate 913 and a second side plate 917. Both sides of the cover plate are respectively connected to the first side plate 913 and the second side plate 917. The first side plate 913 and the second side plate 917 are arranged opposite to each other. In this way, the cover plate, the first side plate 913 and the second side plate 917 forms a U-shaped structure.

The cover plate includes a first cover plate 911 and a second cover plate 912. A width of the first cover plate 911 is smaller than a width of the second cover plate 912, such that a width of a left side of the first protective cover 910 is smaller than a width of a right side of the first protective cover 910. The first protective cover 910 is designed in a frustum cone-like shape.

In some embodiments, the second cover plate 912 is covered on the sleeve 905 of the optical cable plug 900, and the first cover plate 911 is covered on a tail sleeve on the left side of the optical cable plug 900, so as to cover the first protective cover 910 on the upper side of the optical cable plug 900.

The first side plate 913 may be formed thereon with a positioning post 915 and a positioning hole 916 that are arranged on the first side plate 913 along a left-right direction. For example, the positioning post 915 is located on a right side of the first side plate 913, and the positioning hole 916 is located on a left side of the first side plate 913.

The second side plate 917 may also be formed thereon with a positioning post and a positioning hole, and the positioning post and the positioning hole are arranged on the second side plate 917 along the left-right direction. For example, the positioning post is located on the left side of the second side plate 917, and the positioning hole is located on the right side of the second side plate 917. The positioning hole 916 on the first side plate 913 is arranged corresponding to the positioning post on the second side plate 917, and the positioning post 915 on the first side plate 913 is arranged corresponding to the positioning hole on the second side plate 917, such that the positioning posts on the first protective cover 910 are arranged diagonally, and the positioning holes are arranged diagonally.

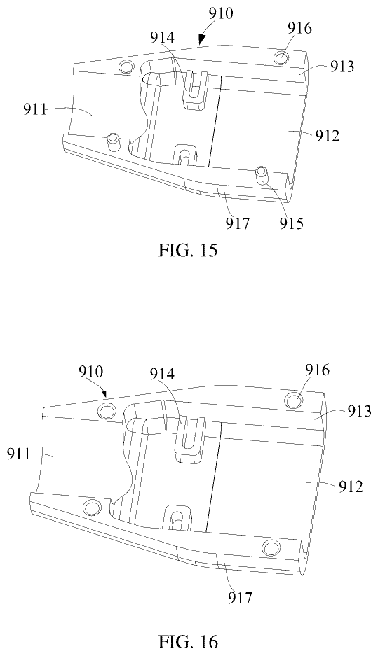

FIG. 15 is a second structural diagram of a first protective cover of an optical module provided according to some embodiments of the present disclosure. As shown in FIG. 15, in the case that the structures of the first protective cover 910 and the second protective cover 920 are the same, the first side plate 913 may be formed thereon with several positioning holes 916, and the second side plate 917 may be formed thereon with several positioning posts 915, and the positioning posts are arranged opposite to the positioning holes, such that the positioning posts on the first protective cover 910 are arranged on a single side, and the positioning holes thereon are arranged on a single side.

When the first protective cover 910 is engaged and connected with the second protective cover 920, the positioning post on the first protective cover 910 is inserted into the positioning hole on the second protective cover 920, and the positioning post on the second protective cover 920 is inserted into the positioning hole on the first protective cover 910, so as to shield and protect the sleeve 905 through the first protective cover 910 and the second protective cover 920.

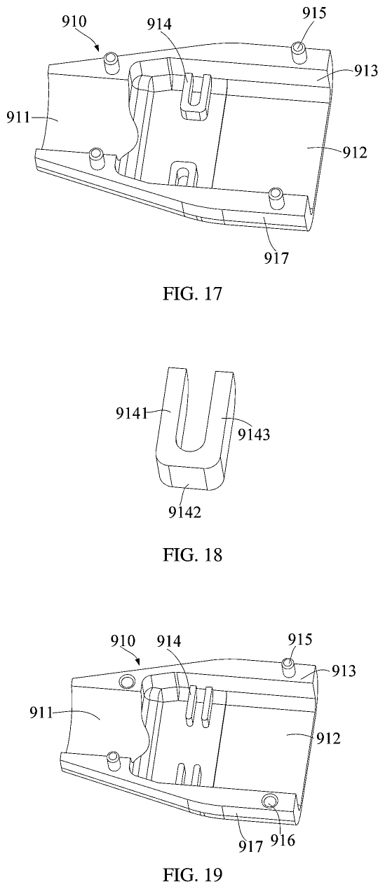

FIG. 16 is a third structural diagram of a first protective cover of an optical module provided according to some embodiments of the present disclosure, and FIG. 17 is a fourth structural diagram of a first protective cover of an optical module provided according to some embodiments of the present disclosure. As shown in FIG. 16 and FIG. 17, the structures of the first protective cover 910 and the second protective cover 920 may also be different. Exemplarily, the first protective cover 910 is designed as a top cover, and the second protective cover 920 is designed as a bracket; the first side plate 913 and the second side plate 917 of the first protective cover 910 may both be provided with positioning holes, and the side plates of the second protective cover 920 may both be provided with positioning posts.

After the plug-in portion 901 of the optical cable plug 900 is inserted into the claw member 710, the first protective cover 910 is first covered on the upper side of the sleeve 905, and then the second protective cover 920 is placed on the lower side of the sleeve 905 such that the positioning posts on the second protective cover 920 are inserted into the positioning holes on the first protective cover 910, to achieve the connection among the optical cable plug 900, the first protective cover 910 and the second protective cover 920.

Referring to FIG. 17, in some embodiments, in the case that the structures of the first protective cover 910 and the second protective cover 920 are different, the first side plate 913 and the second side plate 917 of the first protective cover 910 may be provided with the positioning posts, and the side plates of the second protective cover 920 may be provided with the positioning holes. After the plug-in portion 901 of the optical cable plug 900 is inserted into the claw member 710, the first protective cover 910 is first covered on the upper side of the sleeve 905, and then the second protective cover 920 is placed on the lower side of the sleeve 905 such that the positioning posts on the first protective cover 910 are inserted into the positioning holes on the second protective cover 920 to achieve engagement and connection among the optical cable plug 900, the first protective cover 910 and the second protective cover 920.

FIG. 18 is a structural diagram of a locking boss of an optical module provided according to some embodiments of the present disclosure. As shown in FIG. 14 and FIG. 18, after the first protective cover 910 and the second protective cover 920 are covered on the optical cable plug 900, in order to improve the plugging stability between the optical cable plug 900 and the claw member 710, the locking mechanism 931 includes a locking boss 914 formed on an inner surface of the protective cover 930a. For example, the locking boss 914 may be formed in the first protective cover 910 or the second protective cover 920, or both the first protective cover 910 and the second protective cover 920 may be formed with the locking boss 914. With the sleeve 905 being held by the locking boss 914, the anti-disassembly function of the optical cable plug 900 is achieved.

In some embodiments, the locking boss 914 is formed on the inner side of the second cover plate 912, the locking boss 914 is located between the first side plate 913 and the second side plate 917, and the locking boss 914 is arranged along a width direction of the second cover plate 912; a limiting groove 907 is formed on the connecting portion 906 of the optical cable plug 900, and the limiting groove 907 is close to the left side of the connecting portion 906. When the sleeve 905 is located on the left side of the connecting portion 906, the sleeve 905 hides the limiting groove 907.

After the plug-in portion 901 of the optical cable plug 900 is inserted into the claw member 710, the sleeve 905 is moved to the right to lock the optical cable plug 900 and the claw member 710, and then the first protective cover 910 and the second protective cover 920 are covered on the optical cable plug 900, such that the locking boss 914 is embedded in the limiting groove 907. The locking boss 914 can prevent the sleeve 905 from sliding left and right on the connecting portion 906, thereby realizing the anti-disassembly function of the optical cable plug 900.

In some embodiments, two locking bosses 914, namely a first locking boss and a second locking boss, may be formed on the inner side of the second cover plate 912. One locking boss 914, such as the first locking boss, extends from an inner side of the first side plate 913 toward the second side plate 917, and the other locking boss 914, such as the second locking boss, extends from an inner side of the second side plate 917 toward the first side plate 913, and there is a gap between the two locking bosses 914.

The connecting portion 906 may be formed thereon with two limiting grooves, and one limiting groove 907 is arranged corresponding to one locking boss 914. The two locking bosses 914 are respectively embedded in the limiting grooves 907 on the optical cable plug 900 to lock and limit the sleeve 905 through the locking bosses 914.

The connecting portion 906 may also be formed thereon with one limiting groove 907, and the limiting groove 907 is arranged around the side of the connecting portion 906, that is, the limiting groove 907 is a limiting groove. In this way, two locking bosses 914 are embedded in one limiting groove, and the sleeve 905 is locked and limited by the locking bosses 914.

Referring to FIG. 18, in some embodiments, the locking boss 914 may include a first plate 9141, a second plate 9143 and a connecting plate 9142. Two ends of the connecting plate 9142 are respectively connected to the first plate 9141 and the second plate 9143, and the first plate 9141 and the second plate 9143 are arranged opposite to each other. In this way, the first side plate 913, the first plate 9141, the connecting plate 9142 and the second plate 9143 form a U-shaped structure.

In some embodiments, when the locking boss 914 is a U-shaped rib, for example, the first locking boss and the second locking boss are U-shaped ribs, and the locking boss 914 support the first side plate 913 and the second side plate 917, such that the outer side of the second cover plate 912 is not easy to shrink, and the appearance is smooth and beautiful. The U-shaped rib is high in strength, and can effectively realize the anti-disassembly function of the optical cable plug 900.

FIG. 19 is a fifth structural diagram of a first protective cover of an optical module provided according to some embodiments of the present disclosure. As shown in FIG. 19, the locking boss 914 on the second cover plate 912 can also be designed as two ribs, that is, one end of the U-shaped rib has an opening, to form two parallel ribs, the two ribs are embedded in the limiting groove 907, and one rib is abutted against the sleeve 905, so that the sleeve 905 is locked and limited by the two ribs.

In some embodiments, two locking bosses 914 are formed on the inner side of the second cover plate 912, and each locking boss includes two ribs arranged left to right, that is, the first locking boss includes two ribs, and the second locking boss includes two ribs; and there is a gap between the two ribs. Two ribs are arranged on the inner side of the second cover plate 912, and the first side plate 913 and the second side plate 917 are supported by the ribs, so that the outer side of the second cover plate 912 is not easy to shrink, and the appearance is smooth and beautiful.

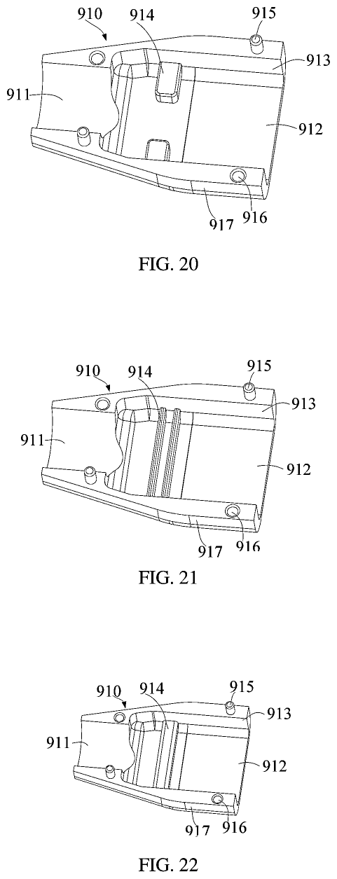

FIG. 20 is a sixth structural diagram of the first protective cover of an optical module provided according to some embodiments of the present disclosure. As shown in FIG. 20, the locking boss 914 on the second cover plate 912 may also be a raised platform, and two raised platforms are formed on the inner side of the second cover plate 912, one raised platform extends from the first side plate 913 toward the second side plate 917, and the other extends from the second side plate 917 toward the first side plate 913, and there is a gap between the two raised platforms. In this way, when the first protective cover 910 and the second protective cover 920 are covered on the sleeve 905, the raised platforms are embedded in the limiting groove 907, and one side of each raised platform is in contact with the sleeve 905, and the sleeve 905 is locked and limited by the raised platforms.

In a case that a raised platform with a certain thickness is provided in the second cover plate 912, the outer side of the second cover plate 912 may be easily shrunk due to the large thickness of the raised platform, resulting in a poor appearance.

FIG. 21 is a seventh structural diagram of the first protective cover of an optical module provided according to some embodiments of the present disclosure. As shown in FIG. 21, the locking boss 914 on the second cover plate 912 may also be designed as two ribs, and each of the two ribs extends from the inner side of the first side plate 913 to the inner side of the second side plate 917. The two ribs are arranged along the left-right direction, and there is a gap between the two ribs in the left-right direction. In this way, when the first protective cover 910 and the second protective cover 920 are covered on the sleeve 905, the two ribs are embedded in the limiting groove 907, and the sleeve 905 is locked and limited by the two ribs.

In the case that two ribs are provided on the second cover plate 912, which extend from the first side plate 913 to the second side plate 917, the limiting groove 907 formed on the connecting portion 906 needs to run across a width direction of the connecting portion 906. However, the limiting groove 907 designed in this way may be not suitable for all optical cable plugs 900, and thus the first protective cover 910 and the second protective cover 920 of this structure may not be adapted to all AOC optical cables on the market.

FIG. 22 is an eighth structural diagram of a first protective cover of an optical module provided according to some embodiments of the present disclosure. As shown in FIG. 22, the locking boss 914 on the second cover plate 912 may also be designed as one rib, the rib has a certain wall thickness, and extends from the inner side of the first side plate 913 to the inner side of the second side plate 917; and the limiting groove 907 on the connecting portion 906 is a limiting groove. In this way, when the first protective cover 910 and the second protective cover 920 are covered on the sleeve 905, the wider rib is embedded in the limiting groove, and the sleeve 905 is locked and limited by one wider rib.

In the case that one rib, which runs from the first side plate 913 to the second side plate 917, is provided on the second cover plate 912, since the rib has a relatively thick wall, it may cause the outer side of the second cover plate 912 to shrink, resulting in a poor appearance, and thus it may be unable to adapt to all AOC optical cables on the market.

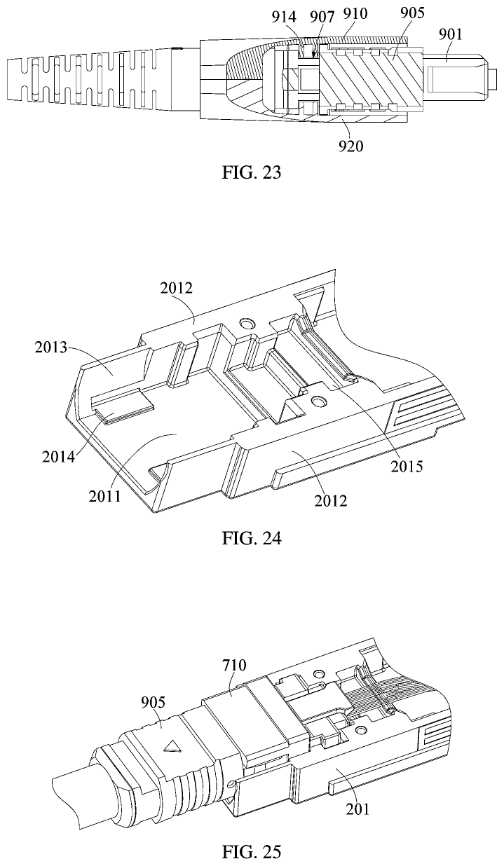

FIG. 23 is a sectional view of an optical cable plug and a protective cover of an optical module provided according to some embodiments of the present disclosure in an assembled state. As shown in FIG. 23, the optical cable plug 900 is inserted into the optical fiber adapter 700, and the optical cable plug 900 is locked and connected with the claw member 710 of the optical fiber adapter 700 through the sleeve 905, and then the first protective cover 910 and the second protective cover 920 are covered on the optical cable plug 900, and the locking bosses 914 on the first protective cover 910 and the second protective cover 920 are embedded in the limit groove 907 on the optical cable plug 900, the first protective cover 910 and the second protective cover 920 are engaged and connected to each other, the sleeve 905 on the optical cable plug 900 cannot slide on the connecting portion 906 of the optical cable plug 900 because of the locking bosses 914, and the first protective cover 910 and the second protective cover 920 shield the sleeve 905, such that the operator cannot contact the sleeve 905, thereby preventing abnormal disassembly of the optical cable plug 900.

When the operator wants to separate the optical cable plug 900 from the optical fiber adapter 700, the operator first separates the first protective cover 910, the second protective cover 920 and the optical cable plug 900, and then pushes the sleeve 905 to the left to facilitate pulling the first engaging parts 7101 such that the first engaging parts 7101 on the claw member 710 are disengaged from the first engaging groove 904 and the second engaging groove 908 on both sides of the optical cable plug 900, so as to achieve the separation of the optical cable plug 900 from the optical fiber adapter 700, thereby converting the AOC optical module into a non-AOC optical module.

In some embodiments, when inserting the optical cable plug 900 into the claw member 710, a part of the sleeve 905 on the optical cable plug 900 may be inserted into the optical port formed by the upper shell part 201 and the lower shell part 202, such that the optical cable plug 900 is sufficiently inserted, thereby ensuring the installation stability of the optical cable plug 900 and the optical fiber adapter 700.

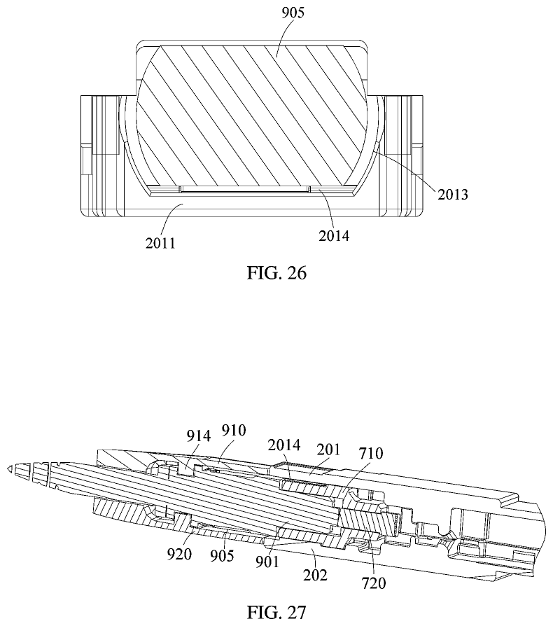

FIG. 24 is a partial structural diagram of an upper shell part of an optical module provided according to some embodiments of the present disclosure, FIG. 25 is a partial assembly diagram of an optical cable plug, an upper shell part and an optical fiber adapter of an optical module provided according to some embodiments of the present disclosure, and FIG. 26 is a sectional view of an optical cable plug, an upper shell part and an optical fiber adapter of an optical module provided according to some embodiments of the present disclosure in an assembled state. As shown in FIG. 24, FIG. 25 and FIG. 26, the upper side plate 2012 of the upper shell part 201 is formed thereon with an arc-shaped plate 2013, which extends from a left side surface of the upper shell part 201 toward a right side of the upper shell part 201; the lower side plate 2022 of the lower shell part 202 is also formed with an arc-shaped plate, which extends from a left side surface of the lower shell part 202 toward a right side of the lower shell part 202. When the optical cable plug 900 is inserted into the optical fiber adapter 700, the arc-shaped plate 2013 contacts the outer arc surface of the sleeve 905, such that the sleeve 905 of the optical cable plug 900 can be inserted into the optical port of the optical module, and the optical cable plug 900 is sufficiently inserted, thereby facilitating the coupling connection between the optical cable plug 900 and the optical fiber plug 720.

In some embodiments, the upper cover plate 2011 of the upper shell part 201 is formed thereon with a baffle 2014, which is arranged in the left-right direction. There is a gap between a left side surface of the baffle 2014 and a left side surface of the upper shell part 201. When inserting the optical cable plug 900 into the optical fiber adapter 700, a bottom surface of the sleeve 905 of the optical cable plug 900 abuts against the baffle 2014, so as to limit the optical cable plug 900 with the baffle 2014 to ensure that the optical cable plug 900 and the optical fiber plug 720 are connected in the claw member 710.

In some embodiments, the upper shell part 201 may be formed thereon with a limiting groove, the limiting groove may extend from the left side surface of the upper shell part 201 toward the right side of the upper shell part, and the limiting groove may be an arc-shaped groove; a convex shell is formed on a right side surface of the first protective cover 910 or the second protective cover, and the convex shell protrudes relative to the right side surface of the protective cover. When the first protective cover 910 and the second protective cover 920 are covered on the optical cable plug 900, the convex shell on the protective cover is embedded in the limiting groove of the upper shell part 201, so as to limit the protective cover through the limiting groove on the shell.

FIG. 27 is a partial sectional view of an optical module provided according to some embodiments of the present disclosure. As shown in FIG. 27, the optical cable plug 900 is inserted into the claw member 710, and a portion of the sleeve 905 is inserted into the optical port formed by the upper shell part 201 and the lower shell part 202; the outer arc surface of the sleeve 905 contacts the arc-shaped plate 2013 on the upper shell part 201 and the arc-shaped plate on the lower shell part 202; the baffle 2014 on the upper shell part 201 limits the sleeve 905, such that the right sides of the first protective cover 910 and the second protective cover 920 which wrap the optical cable plug 900 abut against the left sides of the upper shell part 201 and the lower shell part 202, the optical cable plug 900 is installed in place, and the non-AOC optical module is converted into an AOC optical module.

In some embodiments, a non-AOC optical module is converted into an AOC optical module by connecting the optical cable plug 900 with the optical fiber adapter 700. For optical module manufacturers, they only need to schedule the production of non-AOC optical modules, and when AOC optical modules are needed, they only need to add related cable components, the production conversion is very convenient, which effectively improves the production efficiency of optical modules. Since there is no need to provide new AOC molds, the cost of each set of molds may be reduced by tens of thousands to hundreds of thousands, which effectively reduces the production costs, effectively reduces the inventory cost and improvs turnover efficiency.

For clients, with the optical module which may be changed from an non-AOC optical module to an AOC optical module, procurement costs and installation fees are reduced, which is similar to the separation of the charging plug and the charging cable, the non-AOC optical module is equivalent to the charging head, and customers can randomly switch between optical fiber cables of different lengths such as 1 m, 2 m, 3 m, 5 m, and 10 m according to different usage scenarios, and the switching is very convenient and easy.

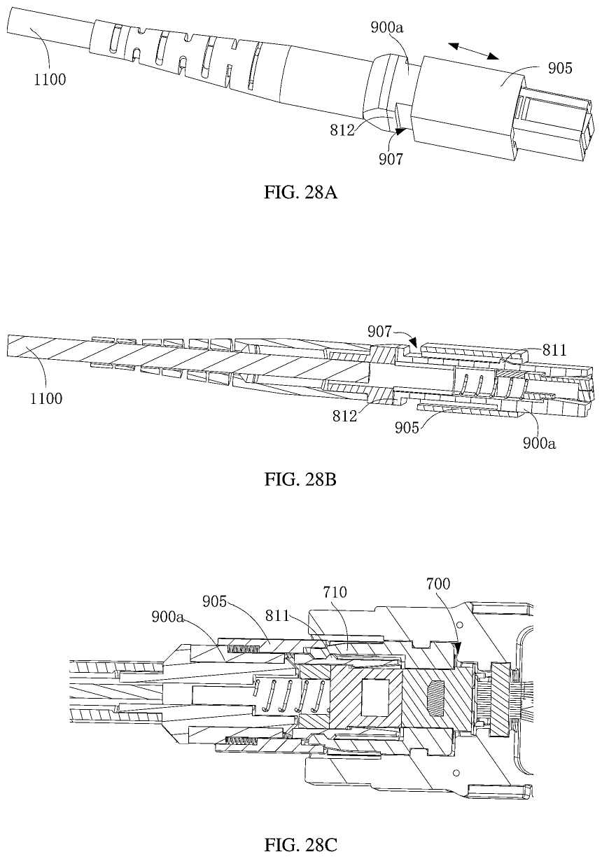

FIG. 28A is a structural diagram of another optical cable plug according to some embodiments, and FIG. 28B is a sectional view of another optical cable plug according to some embodiments. As shown in FIG. 28A and FIG. 28B, similar to the above embodiments, in some embodiments, the sleeve 905 of the optical cable plug 900 can move along the base 900a, for example, the sleeve 905 can move along the arrow directions shown in FIG. 28A. In an exemplary embodiment, the sleeve 905 can move within a preset length range of the base 900a.

In some embodiments, the base 900a is formed with a locking portion 811 (e.g., an engaging groove), and the locking portion 811 may lock and connect the optical fiber adapter 700. The locking portion 811 is located below the sleeve 905, and the locking portion 811 can cooperate with the sleeve 905 to lock the base 900a and the optical fiber adapter 700. For instance, both sides of the base 900a may be disposed with the locking portions 811.

In some embodiments, a limiting boss 812 is formed on a side of one end of the base 900a, and a limiting groove 907 is formed between a side of the limiting boss 812 and one end of the sleeve 905. When the sleeve 905 moves along the base 900a, one end of the sleeve 905 approaches the limiting boss 812, and the limiting groove 907 between the end of the sleeve 905 and the limiting boss 812 is shortened.

FIG. 28C is a first sectional view of another optical module according to some embodiments. FIG. 28C shows a locking state of an optical cable plug and an optical fiber adapter. As shown in FIG. 28C, in some embodiments, the claw member 710 of the optical fiber adapter 700 is configured to lock and connect the optical cable plug 900. In an exemplary embodiment, when the optical cable plug 900 is connected to the optical fiber adapter 700, an inner side of the claw member 710 is assembled and connected with the locking portion 811, and an outer side of the claw member 710 is assembled and connected with the sleeve 905. The sleeve 905, the claw member 710 and the locking portion 811 are assembled and connected to achieve locking and connection between the claw member 710 and the base 900a, thereby achieving locking connection between the optical cable plug 900 and the optical fiber adapter 700.

In some embodiments, when the sleeve 905 is dragged to move toward the limiting boss 812, one end of the sleeve 905 is close to the side of the limiting boss 812, the sleeve 905 is disengaged from the claw member 710, the claw member 710 is then disengaged from the locking portion 811, and then the optical cable plug 900 and the optical fiber adapter 700 are unlocked, thereby enabling the optical fiber connection 900 to be disengaged from the optical fiber adapter 700.

In some embodiments, the optical cable plug 900 may include an elastic member 830, the clastic member 830 may connect the sleeve 905 and the base 900a. The elastic member 830 may be a spring or a tension spring. For example, when unlocking the optical cable plug 900 and the optical fiber adapter 700, an external force overcomes the deformation force of the elastic member 830 to move the sleeve 905, and when the external force becomes smaller or disappears, the sleeve 905 returns to its original position under the deformation force of the elastic member 830. In this way, the elastic member 830 may also help to strengthen the locking of the optical cable plug 900 and the optical fiber adapter 700 to a certain extent, such that an external force, that is less than a certain strength, is not easy to unlock the sleeve 905 and the claw member 710.

In some embodiments, in order to make it more difficult for the optical cable plug 900 and the optical fiber adapter 700 to be unlocked, the optical module 200 may include an anti-unlocking component 930. The anti-unlocking component 930 is disposed on the optical cable plug 900 and is configured to prevent the sleeve 905 from moving.

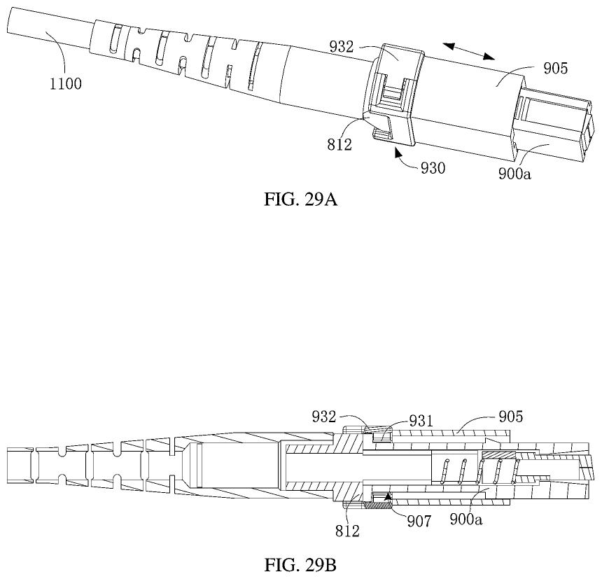

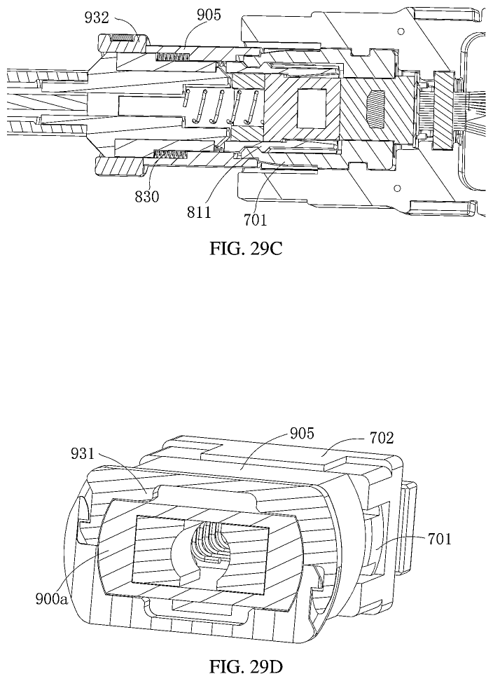

FIG. 29A is a diagram showing a connection state of another optical cable plug and an anti-unlocking component according to some embodiments, and FIG. 29B is a sectional view of another optical cable plug and an anti-unlocking component according to some embodiments. As shown in FIG. 29A and FIG. 29B, different from the above embodiments described in conjunction with FIG. 13 to FIG. 27, in some examples, the anti-unlocking component 930 on the optical cable plug 900 is located at one end of the base 930a, and the anti-unlocking component 930 is configured to prevent the sleeve 905 from moving, so as to prevent the optical cable plug 900 from unlocking from the optical fiber adapter 700, and realize the fixed connection between the optical cable plug 900 and the optical fiber adapter 700.

In some embodiments, when the anti-unlocking component 930 is assembled to the optical cable plug 900, the optical cable plug 900 and the optical fiber adapter 700 cannot be unlocked; when the anti-unlocking component 930 is removed from the optical cable plug 900, the optical cable plug 900 and the optical fiber adapter 700 can be unlocked. In this way, with the arrangement of the anti-unlocking component 930, switching of two modes of pluggable connection and fixed connection between the optical cable plug 900 and the optical fiber adapter 700 is achieved. As an example, the anti-unlocking component 930 is detachably connected to the optical cable plug 900, the sleeve 905 is blocked by the anti-unlocking component 930, which is easier to repair than a case in which the sleeve 905 and the base 930a are fixedly connected by glue.

In some embodiments, the anti-unlocking component 930 may include a locking mechanism 931. The locking mechanism 931 is embedded in the limiting groove 907 to occupy the limiting groove 907, such that the sleeve 905 cannot move toward the limiting boss 812, or a moving distance of the sleeve 905 toward the limiting boss 812 is reduced, and the sleeve 905 and the claw member 710 cannot be separated. The locking mechanism 931 may be a locking protrusion or a locking rib, etc.

In some embodiments, the anti-unlocking component 930 may include a connecting mechanism 932. The connecting mechanism 932 is connected to the base 930a and is arranged outside the locking mechanism 931 to facilitate the connection between the anti-unlocking component 930 and the optical cable plug 900 and to facilitate to embed the locking mechanism 931 in the limiting groove 907. Exemplarily, the connecting mechanism 932 is sleeved on one end of the base 930a. For example, the connecting mechanism 932 tightly enclasps the limiting boss 812.

FIG. 29C is a second sectional view of another optical module according to some embodiments, and FIG. 29B and FIG. 29C show a use state of an anti-unlocking component. As shown in FIG. 29B and FIG. 29C, in some embodiments, the connecting mechanism 932 is connected to the base 930a, and a free end of the locking mechanism 931 is embedded in the limit groove 907. The locking mechanism 931 occupies a space required for the sleeve 905 to be unlocked, such that the sleeve 905 cannot move toward the limiting boss 812 or its moving distance toward the limiting boss 812 is small, making it impossible for the sleeve 905 to be separated from the claw member 710, and the optical cable plug 900 and the optical fiber adapter 700 remain in a locked state.

In some embodiments, one side of the locking mechanism 931 may contact and connect with the side of the limiting boss 812, and the other side of the locking mechanism 931 may contact and connect with an end surface of the sleeve 905, such that the locking mechanism 931 is placed in the limit groove 907 in an interference fit manner, thereby making the sleeve 905 immovable.

In some embodiments, one side of the locking mechanism 931 may contact and connect with the side of the limiting boss 812, but the other side of the locking mechanism 931 does not contact the end face of the sleeve 905, and a distance between the other side of the locking mechanism 931 and said end face should be less than the minimum unlocking moving distance. One side of the locking mechanism 931 contacts the side of the limiting boss 812 makes it convenient to position and assemble the anti-unlocking component 930. Exemplarily, the distance between the other side of the locking mechanism 931 and the end face of the sleeve 905 is greater than one-fourth of the minimum unlocking moving distance, which is convenient for assembling the locking mechanism 931 in the limit groove 907; the distance between the other side of the locking mechanism 931 and the end face of the sleeve 905 is less than half of the minimum unlocking moving distance, which is convenient for preventing the deformation of the sleeve 905 from causing the optical cable plug 900 and the optical fiber adapter 700 to be unlocked.

In some embodiments, one side of the locking mechanism 931 does not contact the side of the limiting boss 812, while the other side of the locking mechanism 931 can contact the end surface of the sleeve 905. The other side of the locking mechanism 931 contacts the end surface of the sleeve 905 makes it convenient to position and assemble the anti-unlocking component 930. The distance between the one side of the locking mechanism 931 and the side of the limiting boss 812 should be less than the minimum unlocking moving distance. Exemplarily, the distance between one side of the locking mechanism 931 and the side of the limiting boss 812 is greater than one-fourth of the minimum unlocking moving distance, which facilitates the assembly of the locking mechanism 931 in the limit groove 907; the distance between the other side of the locking mechanism 931 and the end surface of the sleeve 905 is less than one-third of the minimum unlocking moving distance, which reduces a risk that the anti-unlocking component 930 moves and causes the optical cable plug 900 and the optical fiber adapter 700 to be unlocked.

In some embodiments, a surface of the connecting mechanism 932 is located at a higher level than a surface of the sleeve 905 to prevent the sleeve 905 from moving toward the limiting boss 812 when being deformed, thereby reducing the risk of unlocking the optical cable plug 900 and the optical fiber adapter 700.

FIG. 29D is a sectional view of an optical cable plug and an optical fiber adapter according to some embodiments. As shown in FIG. 29B and FIG. 29D, in some embodiments, the optical fiber adapter 700 has an assembly plane 702 which is configured to assemble and connect with the shell of the optical module 200. When the optical cable plug 900 is locked and connected to the optical fiber adapter 700, the assembly plane 702 protrudes relative to the surface of the sleeve 905. The surface of the connecting mechanism 932 is lower than the assembly plane 702 or is flush with the assembly plane 702, which is convenient for controlling a length, width and height of an assembly formed by the optical cable plug 900 and the anti-unlocking component 930 after they are assembled and connected, so as to control the length, width and height of the assembly formed by the optical cable plug 900 and the anti-unlocking component 930 after they are assembled and connected within a small range on the basis of ensuring the strength of the anti-unlocking component 930, to adapt to size requirements of an optical module, for example, to make the anti-unlocking component 930 adapt to an optical module which has two optical fiber adapters 700 arranged at the optical port.

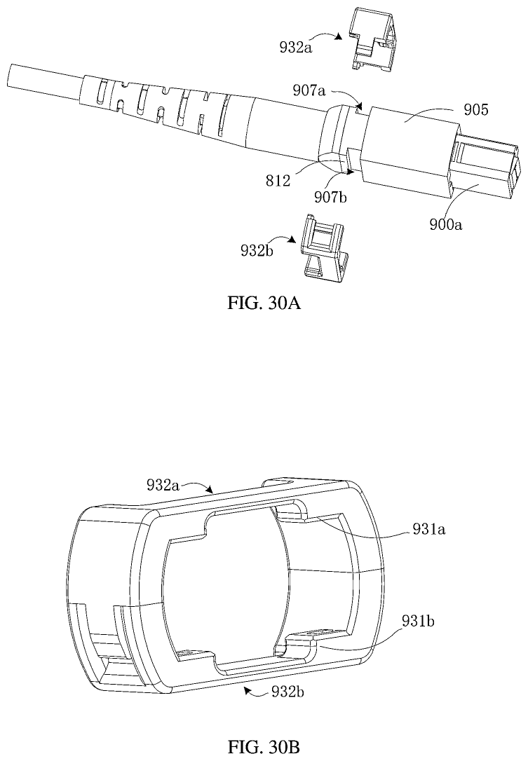

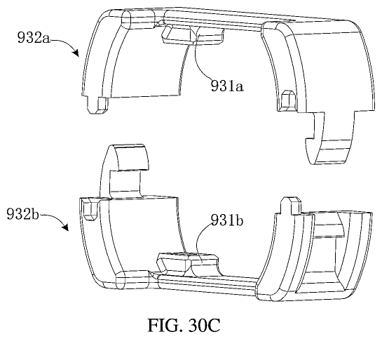

FIG. 30A is an exploded schematic diagram of another optical cable plug and an anti-unlocking component according to some embodiments, FIG. 30B is a structural diagram of an anti-unlocking component according to some embodiments, and FIG. 30C is an exploded diagram of an anti-unlocking component according to some embodiments. As shown in FIG. 30A to FIG. 30C, in some embodiments, a limiting groove 907a is formed on one side of the optical cable plug 900, and a limiting groove 907b is formed on another side of the optical cable plug 900; and several locking mechanisms 931 (e.g., 931a and 931b) are formed on the anti-unlocking component 930 at several positions of the connecting mechanism 932. One locking mechanism 931a is arranged in the limiting groove 907a, and one locking mechanism 931b is arranged in the limiting groove 907b, so as to realize blocking the movement of the sleeve 905 from multiple directions, and to improve the performance of the anti-unlocking component 930 in blocking the movement of the sleeve 905.

In some embodiments, the connection mechanism 932 includes a first connecting member 932a and a second connecting member 932b, one end of the first connecting member 932a is connected to one end of the second connecting member 932b, and the other end of the first connecting member 932a is connected to the other end of the second connecting member 932b. Exemplarily, both ends of the first connecting member 932a may be detachably connected to both ends of the second connecting member 932b, so as to facilitate the assembling of the anti-unlocking component 930 on the optical cable plug 900, and to make the anti-unlocking component 930 miniaturized as much as possible. For example, an engaging part is provided on one end of the first connecting member 932a, an engaging groove is provided on one end of the second connecting member 932b, an engaging groove is provided on the other end of the first connecting member 932a, and an engaging part is provided on the other end of the second connecting member 932b; or, engaging parts are provided on both ends of the first connecting member 932a, and engaging grooves are provided on both ends of the second connecting member 932b; etc.

In some embodiments, the locking mechanism 931a is disposed inside the first connecting member 932a, and the locking mechanism 931b is disposed inside the second connecting member 932b. The first connecting member 932a and the second connecting member 932b are connected to the optical cable plug 900, a free end of the locking mechanism 931a is embedded in the limit groove 907a, and a free end of the locking mechanism 931b is embedded in the limit groove 907b.

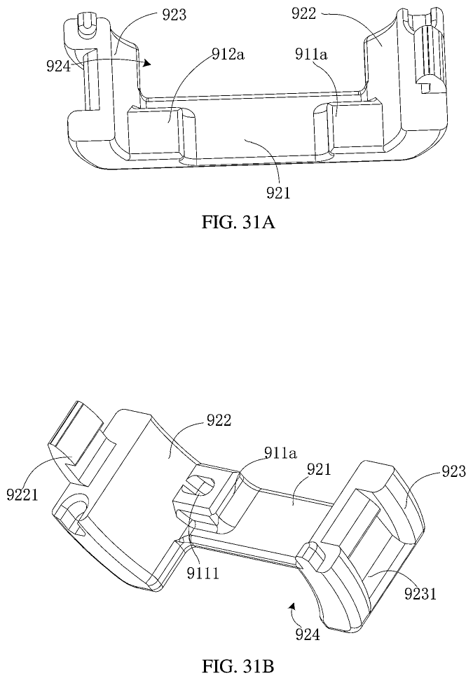

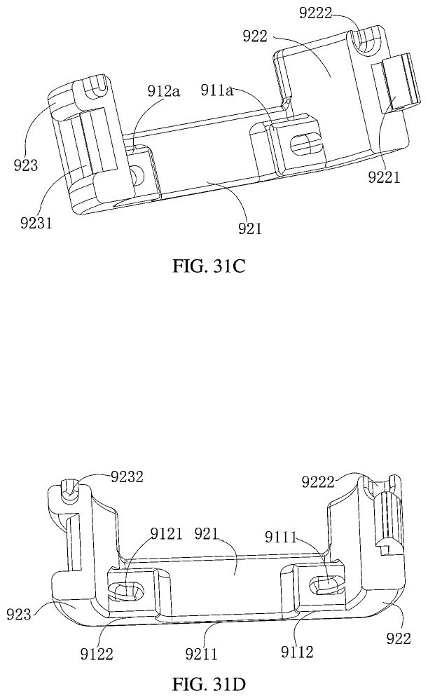

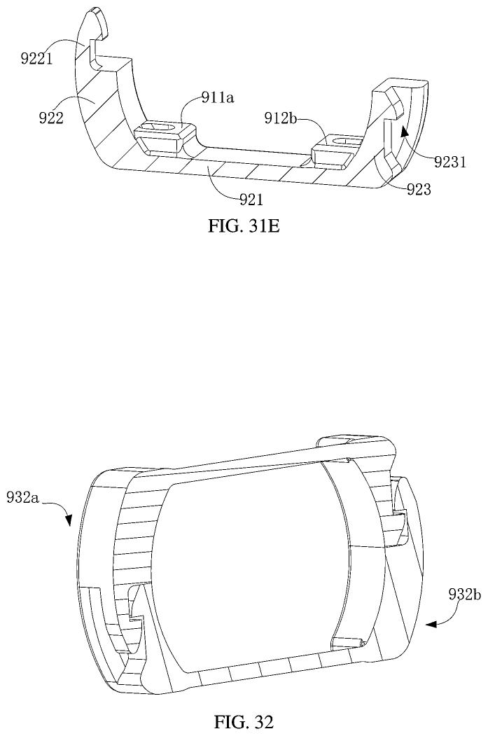

FIG. 31A is a first structural diagram of a connecting member according to some embodiments, FIG. 31B is a second structural diagram of a connecting member according to some embodiments, FIG. 31C is a third structural diagram of a connecting member according to some embodiments, FIG. 31D is a fourth structural diagram of a connecting member according to some embodiments, and FIG. 31E is a sectional view of a connecting member according to some embodiments. FIG. 31A-FIG. 31E show configuration and assembly of a connecting member, wherein the first connecting member 932a and the second connecting member 932b may employ the same or similar configuration.

In some embodiments, the connecting member (i.e., the first connecting member 932a and the second connecting member 932b) may include a bridge portion 921. The bridge portion 921 is located on one side of the optical cable plug 900; the locking mechanism 931 is disposed on an inner side of the bridge portion 921, and an outer side of the bridge portion 921 protrudes relative to the sleeve 905. The locking mechanism 931 is disposed on an inner side of the bridge portion 921.

In some embodiments, one side of the bridge portion 921 covers on the limiting boss 812, and the other side of the bridge portion 921 contacts and connects an end surface of the sleeve 905.

In some embodiments, the locking mechanism 931 includes a first locking protrusion 911a and a second locking protrusion 912a formed on the inner side of the bridge portion 921. The first locking protrusion 911a and the second locking protrusion 912a are embedded in the limit groove 907. Exemplarily, the first locking protrusion 911a is located at one end of the inner side of the bridge portion 921, and the second locking protrusion 912a is located at the other end of the inner side of the bridge portion 921, and there is a gap between the first locking protrusion 911a and the second locking protrusion 912a. Of course, in some embodiments, the first locking protrusion 911a may be connected to the second locking protrusion 912a to form a locking protrusion that runs through one end of the inner side of the bridge portion 921 to the other end of the inner side of the bridge portion 921.

In some embodiments, a first groove 9111 may be formed on the first locking protrusion 911a. The first groove 9111 may reduce defects generated when molding the first locking protrusion 911a so as to increase the strength of the first locking protrusion 911a. Exemplarily, a depth of the first groove 9111 is less than a thickness of the first locking protrusion 911a.

In some embodiments, the second locking protrusion 912a may be formed thereon with a second groove 9121. The second groove 9121 may reduce defects generated when molding the second groove 9121 so as to increase the strength of the second locking protrusion 912a. Exemplarily, a depth of the second groove 9121 is less than a thickness of the second locking protrusion 912a.

In some embodiments, a first blocking surface 9112 is formed on the first locking protrusion 911a, and the first blocking surface 9112 is located at one side edge of the first locking protrusion 911a. The first blocking surface 9112 is configured to abut against the end surface of the sleeve 905. A second blocking surface 9211 is formed on the bridge portion 921, and the second blocking surface 9211 is located at one side edge of the bridge portion 921. The second blocking surface 9211 is configured to abut against the end surface of the sleeve 905. The first blocking surface 9112 can be flush with the second blocking surface 9211.

In some embodiments, a third blocking surface 9122 is formed on the second locking protrusion 912a, and the third blocking surface 9122 is located at one side edge of the second locking protrusion 912a. The third blocking surface 9122 is configured to abut against the end surface of the sleeve 905. The third blocking surface 9122 can be flush with the second blocking surface 9211.

In one embodiment, a width of the first locking protrusion 911a is smaller than a width of the bridging portion 921, and a width of the second locking protrusion 912a is smaller than the width of the bridging portion 921, so as to facilitate assembling the first locking protrusion 911a and the second locking protrusion 912a in the limit groove 907, and to block the sleeve 905 via the bridging portion 921.

In some embodiments, the connecting member may include a first connecting portion 922 and a second connecting portion 923. One end of the bridge portion 921 is connected with the first connecting portion 922, and the other end of the bridge portion 921 is connected with the second connecting portion 923. An inner side surface of the first connecting portion 922 and is opposite to an inner side surface of the second connecting portion 923, and the inner side surface of the first connecting portion 922 and the inner side surface of the second connecting portion 923 are configured to assemble and connect with the base 930a. The first connecting portion 922 may be formed thereon with an engaging groove, an engaging part, a positioning hole or a positioning post, etc.; and the second connecting portion 923 may be formed thereon with an engaging groove, an engaging part, a positioning hole or a positioning post, etc.

In some embodiments, the first locking protrusion 911a is connected with the first connecting portion 922, and the second locking protrusion 912a is connected with the second connecting portion 923, so as to increase strengths of the first locking protrusion 911a and the second locking protrusion 912a, thereby avoiding an external force caused by movement of the sleeve 905 from damaging the first locking protrusion 911a and the second locking protrusion 912a.

In some embodiments, the width of the bridge portion 921 is smaller than a width of the first connecting portion 922, and the width of the bridge portion 921 is smaller than a width of the second connecting portion 923. Exemplarily, a connection between the bridge portion 921 and the first connecting portion 922 is away from one side of the first connecting portion 922, and a connection between the bridge portion 921 and the second connecting portion 923 is away from one side of the second connecting portion 923, such that a gap 924 is formed by the first connecting portion 922 and the second connecting portion 922 at one side of the bridge portion 921. The gap 924 may avoid or make way for the limiting boss 812, which helps to reduce a height of the connecting member in a direction perpendicular to an extension direction of the base 930a. In this way, it is convenient to control a size of the anti-unlocking component 930, prevent the unlocking component 930 from being too large, and to increase the connection strength between the connecting members.

In some embodiments, the width of the bridging portion 921 is greater than or equal to half the width of the first connecting portion 922, which is convenient for ensuring the strength of the bridging portion 921; the width of the bridging portion 921 is less than or equal to three quarters of the width of the first connecting portion 922, which helps to control the size of the anti-unlocking component 930.

In some embodiments, an engaging part 9221 may be formed on an end surface of the first connecting portion 922. Of course, the engaging part 9221 may also be disposed on an outer side surface of the first connecting portion 922.

In some embodiments, a positioning hole 9222 may be formed on the end surface of the first connecting portion 922; or a positioning post may be formed on the end surface of the first connecting portion 922. For example, the positioning hole 9222 may run through a side surface of the first connecting portion 922.

In some embodiments, an outer side surface of the second connecting portion 923 may be formed thereon with an engaging groove 9231, and the engaging groove 9231 may run through the end surface of the second connecting portion 923.

In some embodiments, a positioning post 9232 may be formed on the end surface of the second connecting portion 923; or the end surface of the second connecting portion 923 may be formed therein with a positioning hole. Exemplarily, the positioning post 9232 is close to the side surface of the first connecting portion 922.

FIG. 32 is a sectional view of an anti-unlocking component according to some embodiments, and FIG. 32 shows a connection state of the first connecting member and the second connecting member. As shown in FIG. 32, in some embodiments, a positioning post of the second connecting member 932b is embedded in a positioning hole of the first connecting member 932a, and a positioning post of the first connecting member 932a is embedded in a positioning hole of the second connecting member 932b. This facilitates the positioning and connection between the first connecting member 932a and the second connecting member 932b, and improves the assembly accuracy of the first connecting member 932a and the second connecting member 932b. Of course, in some embodiments, the first connecting member 932a and the second connecting member 932b may be fixedly connected through the positioning post and the positioning hole.

In some embodiments, an engaging part of the first connecting member 932a is connected with an engaging groove of the second connecting member 932b, and an engaging groove of the first connecting member 932a is connected to an engaging part of the second connecting member 932b. This facilitates the fixed connection between the first connecting member 932a and the second connecting member 932b, and improves the connection strength between the first connecting member 932a and the second connecting member 932b.

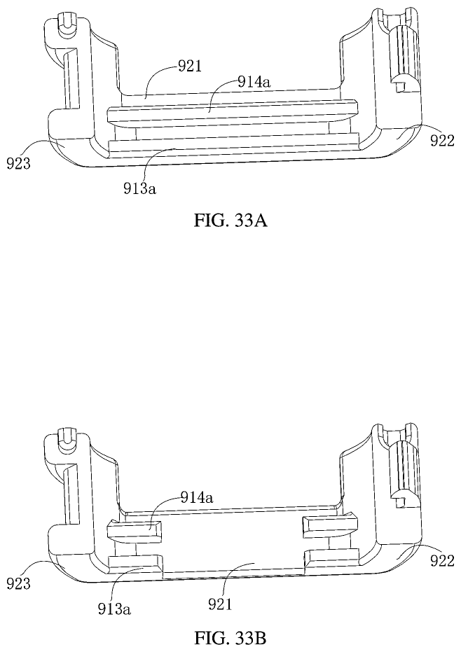

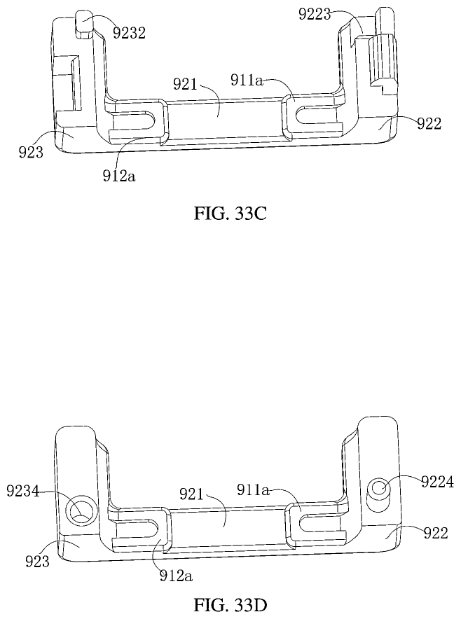

FIG. 33A is a structural diagram of another connecting member according to some embodiments. As shown in FIG. 33A, in some embodiments, a first limiting rib 913a and a second limiting rib 914a are formed on the inner side of the bridge portion 921, and there is a gap between an inner side surface of the first limiting rib 913a and an inner side surface of the second limiting rib 914a. An outer side surface of the first limiting rib 913a is used to abut against the end surface of the sleeve 905, and an outer side surface of the second limiting rib 914a is used to abut against a wall of the limiting groove 907 away from the sleeve 905, that is, the side surface of the limiting boss 812. In an example, the first limiting rib 913a extends from one end of the bridge portion 921 to the other end of the bridge portion 921, and the second limiting rib 914a extends from one end of the bridge portion 921 to the other end of the bridge portion 921.

In some embodiments, a distance between the outer side surface of the first limiting rib 913a and the outer side surface of the second limiting rib 914a is less than the width of the bridge portion 921. For example, the outer side surface of the first limiting rib 913a may be flush with the outer side surface of the bridge portion 921.

In some embodiments, one end of the first limiting rib 913a is connected with the first connecting portion 922, and the other end of the first limiting rib 913a is connected with the second connecting portion 923, so as to increase the strength of the first limiting rib 913a, thereby improving the strength of the first limiting rib 913a to block the sleeve 905.

In some embodiments, one end of the second limiting rib 914a is connected with the first connecting portion 922, and the other end of the second limiting rib 914a is connected with the second connecting portion 923, so as to increase the strength of the second limiting rib 914a and thereby enhance the strength of the second limiting rib 914a against the limiting boss 812.

FIG. 33B is a second structural diagram of another connecting member according to some embodiments. As shown in FIG. 33B, in some embodiments, the first limiting rib 913a is discontinuous, and the second limiting rib 914a is discontinuous, so as to adapt to an optical cable plug 900 with a foolproof structure on the base 930a.

FIG. 33C is a third structural diagram of another connecting member according to some embodiments. As shown in FIG. 33C, in some embodiments, the end surface of the first connecting member 922 may be formed thereon with a positioning notch 9223, and the positioning notch 9223 runs through the inner side surface of the first connecting member 922. A positioning post 9232 may be formed on the end surface of the second connecting member 923, and the positioning post 9232 is close to the inner side surface of the second connecting member 923. The positioning post on the first connecting member 932a may be positioned and connected in the positioning notch on the second connecting member 932b, and the positioning post on the second connecting member 932b may be positioned and connected in the positioning notch on the first connecting member 932a.

FIG. 33D is a fourth structural diagram of another connecting member according to some embodiments. As shown in FIG. 33D, in some embodiments, an assembly column 9224 may be formed on the end surface of the first connecting member 922, and the end surface of the second connecting member 923 may be formed thereon with an assembly hole 9234. The assembly column on the first connecting member 932a may be assembled and connected in the assembly hole on the second connecting member 932b, and the assembly column on the second connecting member 932b may be assembled and connected in the assembly hole on the first connecting member 932a.

In one embodiment, the assembly column 9224 may be located on an axis from the first locking protrusion 911a to the second locking protrusion 912a, and the assembly hole 9234 may be located on the axis from the first locking protrusion 911a to the second locking protrusion 912a. In this way, the first connecting member 932a and the second connecting member 932b can be firmly connected through the assembly column and the assembly hole.

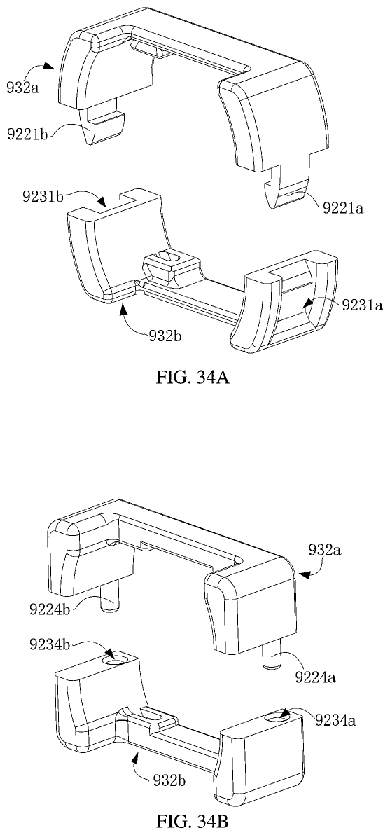

FIG. 34A is an exploded view of another anti-unlocking component according to some embodiments. As shown in FIG. 34A, in some embodiments, on the first connecting member 932a, the end surface of the first connecting portion is formed with a first engaging part 9221a, and the end surface of the second connecting portion is formed with a second engaging part 9221b; and on the second connecting member 932b, the end surface of the first connecting portion is formed with a first engaging groove 9231a, and the end surface of the second connecting portion is formed with a second engaging groove 9231b. The first engaging part 9221a is assembled and connected in the first engaging groove 9231a, and the second engaging part 9221b is assembled and connected in the second engaging groove 9231b.

FIG. 34B is an exploded view of another anti-unlocking component according to some embodiments. As shown in FIG. 34B, in some embodiments, on the first connecting member 932a, the end surface of the first connecting portion 922 is formed with a first assembly column 9224a, and the end surface of the second connecting portion 923 is formed with a second assembly column 9224b; and on the second connecting member 932b, the end surface of the first connecting portion 922 is formed with a first assembly hole 9234a, and the end surface of the second connecting portion 923 is formed with a second assembly hole 9234b. The first assembly column 9224a is assembled and connected in the first assembly hole 9234a, and the second assembly column 9224b is assembled and connected in the second assembly hole 9234b.

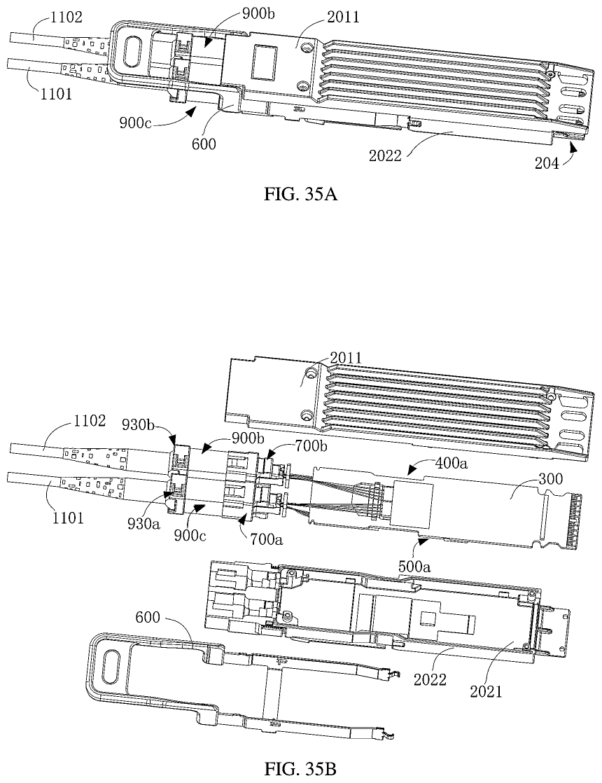

FIG. 35A is a structural diagram of another optical module according to some embodiments, and FIG. 35B is an exploded diagram of another optical module according to some embodiments. In some embodiments, as shown in FIG. 35A and FIG. 35B, the optical module 200 may include a first optical fiber adapter 700a and a second optical fiber adapter 700b; and the first optical fiber adapter 700a and the second optical fiber adapter 700b are respectively connected to the optical emission component 400a and the optical reception component 500a through an optical fiber ribbon. The first optical fiber adapter 700a and the second optical fiber adapter 700b are arranged side by side at the optical port of the optical module 200. The structural form and use of the first optical fiber adapter 700a and the second optical fiber adapter 700b may refer to the optical fiber adapter 700 in the above embodiment.

In some embodiments, the optical module 200 may include a first optical cable 1101 and a second optical cable 1102, wherein a first optical cable plug 900c is disposed at an end of the first optical cable 1101, and a second optical cable plug 900b is disposed at an end of the second optical cable 1102. The first optical cable plug 900c is connected to the first optical fiber adapter 700a to realize the connection between the first optical fiber adapter 700a and the first optical cable 1101; the second optical cable plug 900b is connected to the second optical fiber adapter 700b, and the second optical fiber adapter 700b is connected to the second optical cable 1102. Exemplarily, the first optical cable plug 900c is detachably connected to the first optical fiber adapter 700a, and the second optical cable plug 900b is detachably connected to the second optical fiber adapter 700b. The structural form and use of the first optical cable plug 900c and the second optical cable plug 900b can refer to the optical cable plug 900 in the above-mentioned embodiment.

In some embodiments, the optical module 200 may include a first anti-unlocking component 930a and a second anti-unlocking component 930b. The first anti-unlocking component 930a is disposed on the first optical cable plug 900c, and the first anti-unlocking component 930a is configured to fix and lock the first optical cable plug 900c and the first optical fiber adapter 700a, such that the first optical cable plug 900c is fixedly connected with the first optical fiber adapter 700a, that is, the first optical cable plug 900c and the first optical fiber adapter 700a cannot be easily unlocked. The second anti-unlocking component 930b is disposed on the second optical cable plug 900b, and the second anti-unlocking component 930b is configured to fix and lock the second optical cable plug 900b and the second optical fiber adapter 700b, such that the second optical cable plug 900b is fixedly connected with the second optical fiber adapter 700b, that is, the second optical cable plug 900b and the second optical fiber adapter 700b cannot be easily unlocked. The structural form and use of the first anti-unlocking component 930a and the second anti-unlocking component 930b can refer to the anti-unlocking component 930 in the above embodiment.

In some embodiments, since an unlocking component 600 is disposed outside the shell of the optical module 200, and the unlocking component 600 of the conventional optical module is a sheet metal rubber-encapsulated integrated structure and cannot be rotated. In this way, when the optical cable plug 900 is inserted into the optical fiber adapter 700 and the anti-unlocking component 930, such as the first protective cover 910 and the second protective cover 920, is wrapped around the optical cable plug 900 (the first protective cover 910 is covered on the optical cable plug 900 from top to bottom, and the second protective cover 920 is placed on the optical cable plug 900 from bottom to top), at this time, the unlocking component 600 will hinder the installation of the first protective cover 910 and the second protective cover 920. For this reason, in the optical module provided according to the embodiments of the present disclosure, the unlocking component 600 is designed as a rotatable structure. When the first protective cover 910 and the second protective cover 920 are placed on the optical cable plug 900, the handle of the unlocking component 600 is rotated to prevent the handle from affecting the installation of the first protective cover 910 and the second protective cover 920, so as to realize the optical cable anti-mistaken disassembly function of the AOC optical module.

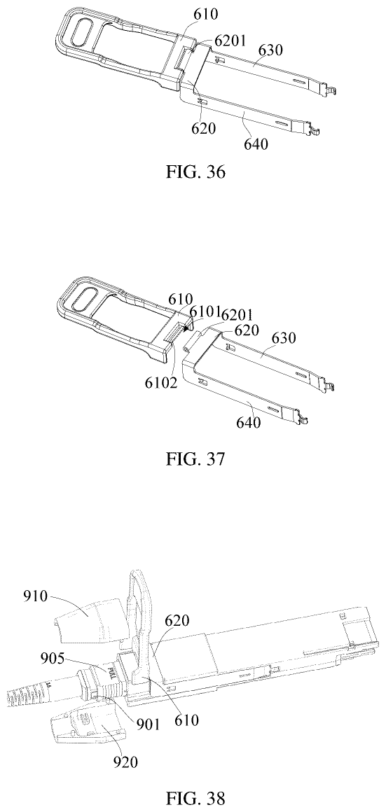

FIG. 36 is a structural diagram of an unlocking component of an optical module provided according to some embodiments of the present disclosure, FIG. 37 is an exploded view of an unlocking component of an optical module provided according to some embodiments of the present disclosure, and FIG. 38 is a diagram illustrating rotation of an unlocking component of an optical module provided according to some embodiments of the present disclosure for assembling. As shown in FIG. 36, FIG. 37 and FIG. 38, the unlocking component 600 includes a handle 610 and an unlocker, and the unlocker includes a cross arm 620, a first unlocking arm 630 and a second unlocking arm 640. Two sides of the cross arm 620 are respectively connected to the first unlocking arm 630 and the second unlocking arm 640; the first unlocking arm 630 and the second unlocking arm 640 are arranged opposite to each other; and the cross arm 620 is located on an outer side of the upper cover plate 2011, and the first unlocking arm 630 and the second unlocking arm 640 are respectively engaged on the upper side plates 2012 on both sides of the upper shell part 201, so as to realize the unlocking of the optical module and the cage 106 of the host computer 100 through the unlocking component 600.

In some embodiments, in order to realize the rotatability of the unlocking component 600, a rotating shaft may be provided on the handle 610, or a rotating shaft may be provided on the unlocker. Exemplarily, when a rotating shaft is provided on the handle 610, one end of the handle 610 facing the unlocker may be formed thereon with an avoidance groove 6101, and a width of the avoidance groove 6101 is smaller than a width of the handle 610; a rotating shaft 6102 may be disposed in the avoidance groove 6101, and both ends of the rotating shaft 6102 are respectively connected to opposite side walls of the avoidance groove 6101 to fix the rotating shaft 6102 in the avoidance groove 6101, and there is a gap between a left side surface of the rotating shaft 6102 and a left side wall of the avoidance groove 6101.

A shaft sleeve 6201 is formed on the cross arm 620, and the shaft sleeve 6201 may pass through the avoidance groove 6101 and be sleeved on the rotating shaft 6102. The rotating shaft 6102 can rotate in the shaft sleeve 6201, the rotating shaft 6102 in turn drives the handle 610 to rotate around the shaft sleeve 6201. In this way, the handle 610 may be rotated clockwise above the upper shell part 201, so as to facilitate the first protective cover 910 and the second protective cover 920 to be placed on the optical cable plug 900.

In some embodiments, two rotating shafts 6102 may be disposed in the avoidance groove 6101, one rotating shaft 6102 extends from one side wall of the avoidance groove 6101 along a width direction of the handle 610, and the other rotating shaft 6102 extends from the other side wall of the avoidance groove 6101 along the width direction of the handle 610, and there is a gap between the two rotating shafts 6102 along the width direction of the handle 610.

Exemplarily, when a rotating shaft is provided on the unlocker, the rotating shaft may be provided at one end of the cross arm 620, and the handle 610 is formed thereon with a groove matching with the rotating shaft, such that the rotating shaft on the cross arm 620 is rotatable in the rotating groove.

The shaft sleeve 6201 may be embedded in the avoidance groove 6101, one rotating shaft 6102 on the avoidance groove 6101 is inserted into one end of the sleeve 6201, and the other rotating shaft 6102 on the avoidance groove 6101 is inserted into the other end of the sleeve 6201, so as to realize the rotatable connection between the handle 610 and the cross arm 620.

Referring to FIG. 38, in some embodiments, when the operator converts the non-AOC optical module into the AOC optical module, the operator grasps the handle 610 and rotates it clockwise such that the handle 610 is rotated above the upper shell part 201, the rotated handle 610 may be perpendicular to the upper shell part 201, to expose the optical port of the optical module; and then the optical cable plug 900 is inserted into the optical fiber adapter 700, the first protective cover 910 is covered on the optical cable plug 900 from top to bottom, and the second protective cover 920 is placed on the optical cable plug 900 from bottom to top, and the sleeve 905 is shielded by the first protective cover 910 and the second protective cover 920. In some embodiments, the handle 610 can be rotated clockwise by 0° to 180°.

After the operator converts the non-AOC optical module into the AOC optical module, the operator grabs the handle 610 and rotates it counterclockwise such that the handle 610 is placed in its original position.

When the operator converts the AOC optical module to a non-AOC optical module, the operator grasps the handle 610 and rotates it clockwise, and turns the handle 610 above the upper shell part 201 to expose the optical port of the optical module; then he may disassemble the first protective cover 910 and the second protective cover 920, pulls out the optical cable plug 900 from the optical fiber adapter 700, and then inserts the external optical fiber 101 into the optical fiber adapter 700; finally, the operator may rotate the handle 610 counterclockwise to place the handle 610 in it's original position, thereby realizing the conversion from the AOC optical module to the non-AOC optical module.

In the optical module provided according to the embodiments of the present disclosure, the unlocking component 600 is designed to be rotatable. The handle 610 of the unlocking component 600 can be rotated around the unlocker, to expose the optical port of the optical module. When switching from a non-AOC optical module to an AOC optical module, the external optical fiber 101 at the optical port may be pulled out, and the optical cable plug 900 at one end of the optical cable 1100 is inserted into the claw member 710 of the optical fiber adapter 700; the first protective cover 910 and the second protective cover 920 are placed on the optical cable plug 900 such that the sleeve 905 is locked with the locking bosses in the first protective cover 910 and the second protective cover 920 to prevent abnormal disassembly of the optical cable plug 900 and the optical fiber adapter 700; finally, the handle 610 is turned counterclockwise to its original position, thereby converting the non-AOC optical module into an AOC optical module. The manufacturer only needs to produce a non-AOC optical module, and when needed, the non-AOC optical module can be converted into an AOC optical module by fixing the optical cable plug 900 with a set of anti-disassembly structures, thereby improving the switching efficiency between non-AOC optical module and AOC optical module.

In some embodiments, as shown in FIG. 6, when the optical module is a non-AOC optical module, an optical signal emitted by the first optical component 400 in the optical module is coupled to the optical fiber adapter 700 via the first optical fiber ribbon 410; the optical signal is then transmitted to the external optical fiber 101 via the optical fiber adapter 700 to achieve emission of a group of lights; an external optical signal transmitted from the external optical fiber 101 is transmitted to the first optical component 400 via the optical fiber adapter 700 and the first optical fiber ribbon 410 to achieve reception of a group of lights. An optical signal emitted by the second optical component 500 in the optical module is coupled to the optical fiber adapter 700 via the second optical fiber ribbon 510; the optical signal is then transmitted to the external optical fiber 101 via the optical fiber adapter 700 to achieve emission of another group of lights; an external optical signal transmitted by the external optical fiber 101 is transmitted to the second optical component 500 via the optical fiber adapter 700 and the second optical fiber ribbon 510 to achieve reception of another group of lights.

When the optical module is an AOC optical module, an optical signal emitted by the first optical component 400 in the optical module is coupled to the optical fiber adapter 700 via the first optical fiber ribbon 410; the optical signal is then transmitted to the optical cable 1100 via the optical fiber adapter 700 and the optical cable plug 900 to achieve emission of a group of lights; an external optical signal transmitted by the optical cable 1100 is transmitted to the first optical component 400 via the optical cable plug 900, the optical fiber adapter 700, and the first optical fiber ribbon 410 to achieve reception of a group of lights. An optical signal emitted by the second optical component 500 in the optical module is coupled to the optical fiber adapter 700 via the second optical fiber ribbon 510; the optical signal is then transmitted to the optical cable 1100 via the optical fiber adapter 700 and the optical cable plug 900 to achieve emission of another group of lights; an external optical signal transmitted by the optical cable 1100 is transmitted to the second optical component 500 via the optical cable plug 900, the optical fiber adapter 700, and the second optical fiber ribbon 510 to achieve reception of another group of lights.

In some embodiments, the first optical component 400 has the same configuration as the second optical component 500. The first optical component 400 includes an optical emission chip, an optical reception chip, a lens assembly and an optical fiber-bracket. The optical emission chip and the optical reception chip are mounted on the circuit board 300. The lens assembly is covered on the optical emission chip and the optical reception chip. The first optical fiber ribbon 410 is connected to the lens assembly through the optical fiber-bracket.

The lens assembly not only realizes the optical coupling between the optical emission chip, the optical reception chip and the first optical fiber ribbon 410, but also protects the optical emission chip and the optical reception chip. However, a precision mold is generally needed for manufacturing the lens assembly, and the mold is expensive and has poor versatility; a high precision is required when assembling the lens assembly and the optical fiber ribbon, and a special assembly fixture is needed. In addition, the lens assembly does not protect the optical fiber ribbon.

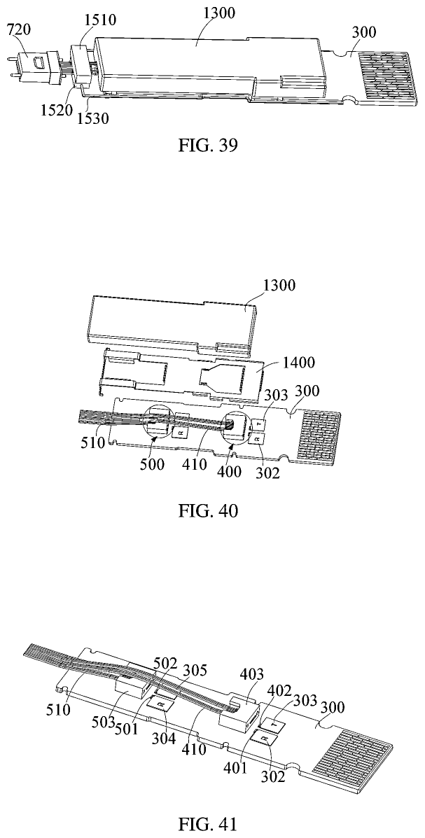

FIG. 39 is a diagram of a circuit board and a shielding component in an optical module provided according to some embodiments of the present disclosure in an assembled state, and FIG. 40 is an exploded diagram of a circuit board and a shielding component in an optical module provided according to some embodiments of the present disclosure. As shown in FIG. 39 and FIG. 40, the optical module provided according to the embodiments of the present disclosure further includes a shielding cover 1300 and a shielding bracket 1400. The shielding bracket 1400 is covered on the circuit board 300, and the shielding bracket 1400 is covered above the optical emission chip and the optical reception chip of the first optical component 400 and the second optical component 500, and the shielding bracket 1400 protects the optical emission chip and the optical reception chip on the circuit board 300 and the first optical fiber ribbon 410 connecting the first optical component 400 and the second optical fiber ribbon 510 connecting the second optical component 500.

The shielding cover 1300 is covered on the shielding bracket 1400, the shielding bracket 1400 supports the shielding cover 1300, and the shielding cover 1300 completely wraps the shielding bracket 1400, thus achieving EMC shielding effect of the optical module through the combination of the shielding cover 1300 and the shielding bracket 1400.

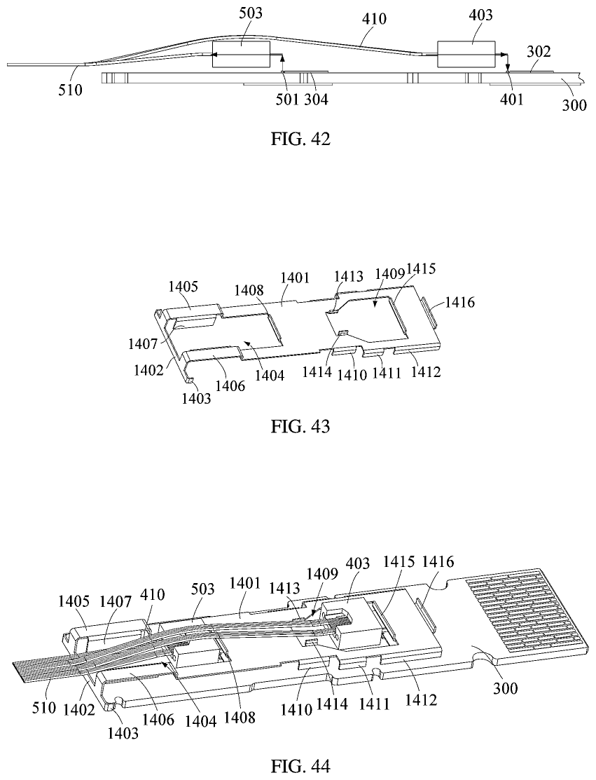

FIG. 41 is a structural diagram of a circuit board of an optical module provided according to some embodiments of the present disclosure, and FIG. 42 is a side view of a circuit board of an optical module provided according to some embodiments of the present disclosure. As shown in FIG. 41 and FIG. 42, the first optical component 400 includes a first optical emission chip 401, a first optical reception chip 402 and a first optical fiber-bracket 403. The first optical emission chip 401, the first optical reception chip 402 and the first optical fiber-bracket 403 are directly mounted on a surface of the circuit board 300; the first optical fiber-bracket 403 is located at a left side of the first optical emission chip 401; and the first optical emission chip 401 and the first optical reception chip 402 are arranged side by side along a width direction of the circuit board 300.

A first driver chip 302 is also provided on the surface of the circuit board 300. The first driver chip 302 may be located at a right side of the first optical emission chip 401. The first driver chip 302 is electrically connected to the first optical emission chip 401, and the first driver chip 302 sends a driving signal to the first optical emission chip 401 to drive the first optical emission chip 401 to generate an optical signal.

A first transimpedance amplifier (TIA) 303 is also provided on the surface of the circuit board 300. The first transimpedance amplifier 303 may be located at one side of the first optical reception chip 402. For example, the first transimpedance amplifier 303 is located at the right side of the first optical reception chip 402. The first transimpedance amplifier 303 is electrically connected to the first optical reception chip 402, an electrical signal output by the first optical reception chip 402 is amplified by the first transimpedance amplifier 303 and then transmitted to the golden finger 301, the electrical signal is then transmitted to the host computer 100 via the golden finger 301.

Referring to FIG. 42, no lens assembly is covered on the first optical emission chip 401 and the first optical reception chip 402; the first optical fiber ribbon 410 is inserted into the first optical fiber-bracket 403, and the right end face of the optical fiber of the first optical fiber ribbon 410 protrudes relative to the right side face of the first optical fiber-bracket 403, and the right end face of the optical fiber is an inclined reflection surface, which is located directly above the first optical emission chip 401 or the first optical reception chip 402. In this way, the first optical emission chip 401 emits a light beam perpendicular to the circuit board 300, and the light beam is reflected into the optical fiber through the reflection surface of the optical fiber, and the reflected light beam is coupled to the optical fiber adapter 700 through the optical fiber, the light beam is then transmitted to the external optical fiber 101 or the optical cable 1100 through the optical fiber adapter 700.

An external light transmitted by the external optical fiber 101 or the optical cable 1100 is transmitted to the first optical fiber ribbon 410 via the optical fiber adapter 700, and the external light is reflected by the reflection surface of the optical fiber of the first optical fiber ribbon 410 to the first optical reception chip 402.

In some embodiments, the second optical component 500 includes a second optical emission chip 501, a second optical reception chip 502 and a second optical fiber-bracket 503. The second optical emission chip 501, the second optical reception chip 502 and the second optical fiber-bracket 503 are directly mounted on the surface of the circuit board 300; the second optical fiber-bracket 503 is located on a left side of the second optical emission chip 501; and the second optical emission chip 501 and the second optical reception chip 502 are arranged side by side along the width direction of the circuit board 300.

A second driver chip 304 is disposed on the surface of the circuit board 300. The second driver chip 304 may be located at the right side of the second optical emission chip 501. The second driver chip 304 is electrically connected to the second optical emission chip 501, and the second driver chip 304 sends a driving signal to the second optical emission chip 501 to drive the second optical emission chip 501 to generate an optical signal.

A second transimpedance amplifier (TIA) 305 is disposed on the surface of the circuit board 300. The second transimpedance amplifier 305 may be located at one side of the second optical reception chip 502. Exemplarily, the second transimpedance amplifier 305 is located at the right side of the second optical reception chip 502. The second transimpedance amplifier 305 is electrically connected to the second optical reception chip 502, an electrical signal output by the second optical reception chip 502 is amplified by the second transimpedance amplifier 305 and then transmitted to the golden finger 301; and the electrical signal is then transmitted to the host computer 100 via the golden finger 301.

In some embodiments, no lens assembly is covered on the second optical emission chip 501 and the second optical reception chip 502; the second optical fiber ribbon 510 is inserted into the second optical fiber-bracket 503, the right end face of the optical fiber of the second optical fiber ribbon 510 protrudes relative to the right side face of the second optical fiber-bracket 503, and the right end face of the optical fiber is an inclined reflection surface, which is located directly above the second optical emission chip 501 or the second optical reception chip 502. In this way, the second optical emission chip 501 emits a light beam perpendicular to the circuit board 300, the light beam is reflected into the optical fiber through the reflection surface of the optical fiber, and the reflected light beam is coupled to the optical fiber adapter 700 through the optical fiber, the light beam is then transmitted to the external optical fiber 101 or the optical cable 1100 through the optical fiber adapter 700.

An external light transmitted by the external optical fiber 101 or the optical cable 1100 is transmitted to the second optical fiber ribbon 510 via the optical fiber adapter 700, and the external light is reflected by the reflection surface of the optical fiber in the second optical fiber ribbon 510 to the second optical reception chip 502.

In some embodiments, a light generated by the optical emission chip is directly reflected into the optical fiber via the reflection surface of the optical fiber, and the external light transmitted by the optical fiber is directly reflected to the optical reception chip via the reflection surface of the optical fiber. There is no need to arrange a lens assembly. In this way, costs related to the molds and the parts are reduced; the assembly accuracy requirements for the optical fiber, the optical emission chip and the optical reception chip are not high; and the assembling operation is convenient and may be made by an operator manually.

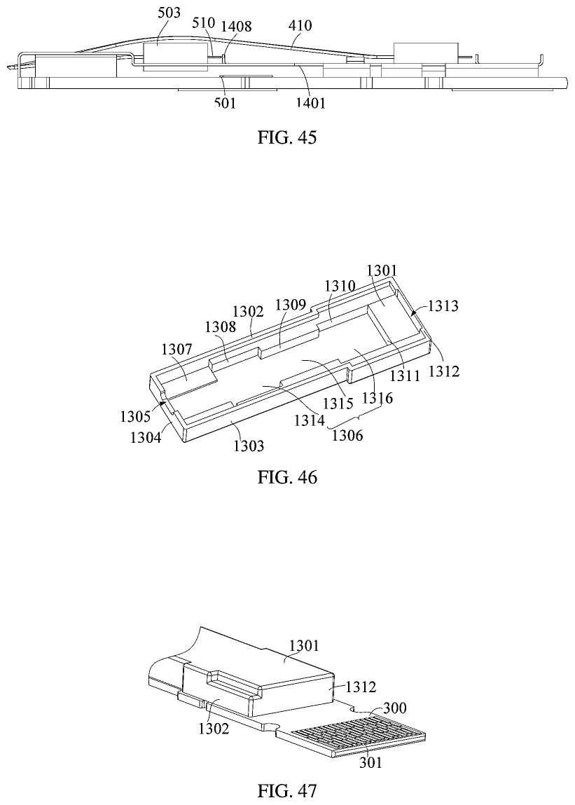

FIG. 43 is a structural diagram of a shielding bracket of an optical module provided according to some embodiments of the present disclosure, FIG. 43 is a diagram of a circuit board and a shielding bracket of an optical module provided according to some embodiments of the present disclosure in an assembled state, and FIG. 44 is a diagram of a circuit board and a shielding bracket of an optical module provided according to some embodiments of the present disclosure in an assembled state, which is shown at another view angle. As shown in FIG. 43, FIG. 44 and FIG. 45, the shielding bracket 1400 includes a bracket body 1401. A first support arm 1410, a second support arm 1411 and a third support arm 1412 are arranged at a side of the bracket body 1401, wherein the first support arm 1410, the second support arm 1411 and the third support arm 1412 extend from the bracket body 1401 toward the circuit board 300; and the bracket body 1401 is connected to the surface of the circuit board 300 through the first support arm 1410, the second support arm 1411 and the third support arm 1412, such that a cavity is formed between the bracket body 1401 and the circuit board 300, and the cavity is configured to accommodate optoelectronic chip(s) on the circuit board 300.

In some embodiments, the first support arm 1410, the second support arm 1411 and the third support arm 1412 are arranged along the left-right direction (e.g., the light transmission direction of the optical module); the second support arm 1411 and the third support arm 1412 are located on the same vertical plane, at this time, the second support arm 1411 is flush with the third support arm 1412; the second support arm 1411 protrudes relative to the first support arm 1410 to increase a width of the right side of the shielding bracket 1400, such that the cavity formed by the shielding bracket 1400 and the circuit board 300 can accommodate more optoelectronic chips, thereby increasing the protection area of the shielding bracket 1400.

A shielding plate 1402 is disposed at the left side of the bracket body 1401, a top surface of the shielding plate 1402 is fixedly connected to the bracket body 1401, a bottom surface of the shielding plate 1402 may be flush with the bottom surface of the circuit board 300, and the shielding plate 1402 is mounted on the left side surface of the circuit board 300 to realize positioning of the shielding bracket 1400 on the circuit board 300 through the shielding plate 1402.

In some embodiments, bent plates 1403 are provided on both sides of the shielding plate 1402. The bent plate 1403 extend from the shielding plate 1402 toward the right side of the circuit board 300, and an inner side of the bent plate 1403 is mounted on the side of the circuit board 300, such that the shielding plate 1402 wraps the left side of the circuit board 300 to achieve close contact between the shielding plate 1402 and the end face of the circuit board 300.

As shown in FIG. 44, the bracket body 1401 is formed thereon with a first avoidance hole 1409 and a second avoidance hole 1404. The first optical emission chip 401, the first optical reception chip 402 and the first optical fiber-bracket 403 are located in the first avoidance hole 1409, such that a light emitted by the first optical emission chip 401 is reflected through the reflection surface of the optical fiber into the optical fiber in the first optical fiber ribbon 410, and a light transmitted by the optical fiber in the first optical fiber ribbon 410 is reflected through the reflection surface of the optical fiber to the first optical reception chip 402; the second optical emission chip 501, the second optical reception chip 502 and the second optical fiber-bracket 503 are located in the second avoidance hole 1404, such that a light emitted by the second optical emission chip 501 is reflected through the reflection surface of the optical fiber into the optical fiber in the second optical fiber ribbon 510, and a light transmitted by the optical fiber in the second optical fiber ribbon 510 is reflected through the reflection surface of the optical fiber to the second optical reception chip 502.

In some embodiments, the first optical emission chip 401 and the first optical reception chip 402 are located in the first avoidance hole 1409; and the first driver chip 302 and the first transimpedance amplifier 303 on the circuit board 300 are located in the cavity formed by the bracket body 1401 and the circuit board 300, to protect the first driver chip 302, the first transimpedance amplifier 303, gold wire connecting the first optical emission chip 401 and the first driver chip 302, and gold wire connecting the first optical reception chip 402 and the first transimpedance amplifier 303, and to avoid damage to the optoelectronic chips and the gold wires on the circuit board 300 during the production process.

A first protective wall 1415 is provided on an edge of one end of the first avoidance hole 1409. The first protective wall 1415 extends from the bracket body 1401 toward the upper shell part 201. After the first optical fiber-bracket 403 is placed in the first avoidance hole 1409, the optical fiber reflection surface protruded relative to the first optical fiber-bracket 403 may abut on the first protective wall 1415. The first protective wall 1415 can limit and protect the first optical fiber-bracket 403 and the first optical fiber ribbon 410 protruded relative to the first optical fiber-bracket 403, so as to prevent damage to the first optical fiber-bracket 403 during the production process, or poor assembly caused by displacement of the first optical fiber-bracket 403.

Two side walls at the other end of the first avoidance hole 1409 are respectively disposed with a first limiting wall 1413 and a second limiting wall 1414. The first limiting wall 1413 and the second limiting wall 1414 extend from the bracket body 1401 toward the upper shell part 201, and the first limiting wall 1413 and the first protective wall 1415 are located on opposite sides of the first optical fiber-bracket 403.

In some embodiments, a width between the first limiting wall 1413 and the second limiting wall 1414 is smaller than a width of the right side of the first avoidance hole 1409, for example, the width between the first limiting wall 1413 and the second limiting wall 1414 is smaller than the width of the first optical fiber-bracket 403. In this way, when the first optical fiber-bracket 403 is placed in the first avoidance hole 1409, the first optical fiber ribbon 410 inserted into the first optical fiber-bracket 403 is placed between the first limiting wall 1413 and the second limiting wall 1414, such that the first optical fiber ribbon 410 is protected and avoided through the first limiting wall 1413 and the second limiting wall 1414, so as to prevent the first optical fiber ribbon 410 from being crushed or damaged when assembling the upper shell part 201.

In some embodiments, the second optical emission chip 501 and the second optical reception chip 502 are located in the second avoidance hole 1404; and the second driver chip 304 and the second transimpedance amplifier 305 on the circuit board 300 are located in the cavity formed by the bracket body 1401 and the circuit board 300, to protect the second driver chip 304, the second transimpedance amplifier 305, gold wire connecting the second optical emission chip 501 and the second driver chip 304, and gold wire connecting the second optical reception chip 502 and the second transimpedance amplifier 305, so as to avoid damage to the optoelectronic chips and gold wires on the circuit board 300 during the production process.

The second avoidance hole 1404 extends from the shielding plate 1402 toward the first avoidance hole 1409. A first support plate 1405 and a second support plate 1406 are arranged between the shielding plate 1402 and the bracket body 1401. Two ends of the first support plate 1405 are fixedly connected to the bracket body 1401 and the shielding plate 1402, respectively; two ends of the second support plate 1406 are fixedly connected to the bracket body 1401 and the shielding plate 1402, respectively; and the first support plate 1405 and the second support plate 1406 are located on opposite sides of the second avoidance hole 1404.

In some embodiments, the first support plate 1405 and the second support plate 1406 may be flush with the bracket body 1401; the first support plate 1405 and the second support plate 1406 may also protrude relative to the bracket body 1401, that is, a distance between each of the first support plate 1405 and the second support plate 1406 and the circuit board 300 is greater than a distance between the bracket body 1401 and the circuit board 300, such that electrical elements with higher installation heights can be placed under the first support plate 1405 and the second support plate 1406.

A fourth support arm 1407 is disposed on one side of the first support plate 1405, and the fourth support arm 1407 extends from the first support plate 1405 toward the circuit board 300; a fifth support arm is disposed on one side of the second support plate 1406, and the fifth support arm extends from the second support plate 1406 toward the circuit board 300; and the fourth support arm 1407 and the fifth support arm are located on opposite sides of the second avoidance hole 1404. In this way, when the shielding bracket 1400 is covered on the circuit board 300, the shielding bracket 1400 is supported by the fourth support arm 1407 and the fifth support arm.

In some embodiments, electrical elements are disposed on the circuit board 300 below the first support plate 1405 and the second support plate 1406, and with the arrangements of the fourth support arm 1407 and the fifth support arm, the height of the left side of the shielding bracket 1400 is raised, such that the shielding bracket 1400 can avoid the electrical elements on the circuit board 300, to thereby protect the electrical elements on the circuit board 300.

In some embodiments, the fourth support arm 1407 and the fifth support arm are configured to raise the height of the left side of the shielding bracket 1400, and the shielding bracket 1400 is designed to have different heights, so as to avoid electrical elements with different heights on the circuit board 300.

When the second optical fiber-bracket 503 is placed in the second avoidance hole 1404, heights of the fourth support arm 1407 and the fifth support arm can be higher than the installation height of the second optical fiber-bracket 503; the second optical fiber ribbon 510 inserted into the second optical fiber-bracket 503 is placed between the fourth support arm 1407 and the fifth support arm; and the first optical fiber ribbon 410 is placed between the fourth support arm 1407 and the fifth support arm after running over the second optical fiber-bracket 503. In this way, when assembling the upper shell part 201, the fourth support arm 1407 and the fifth support arm can support the upper shell part 201, so as to protect the first optical fiber ribbon 410 and the second optical fiber ribbon 510, and prevent the first optical fiber ribbon 410 and the second optical fiber ribbon 510 from being crushed or damaged when assembling the upper shell part 201.

Referring to FIG. 45, in some embodiments, a second protective wall 1408 is provided at an edge of one end of the second avoidance hole 1404. The second protective wall 1408 extends from the bracket body 1401 toward the upper shell part 201, and the second protective wall 1408 and the shielding plate 1402 are located at opposite ends of the second avoidance hole 1404. After the second optical fiber-bracket 503 is placed in the second avoidance hole 1404, the optical fiber reflection surface protruded relative to the second optical fiber-bracket 503 can abut on the second protective wall 1408, and the second protective wall 1408 can limit and protect the second optical fiber-bracket 503 and the second optical fiber ribbon 510 protruded relative to the second optical fiber-bracket 503, so as to prevent the second optical fiber-bracket 503 and the second optical fiber ribbon 510 from being damaged during the production process or avoid poor assembly due to displacement of the second optical fiber-bracket 503 caused during the production process.

In some embodiments, the shielding bracket 1400 may be an elastic sheet metal piece. The shielding bracket 1400 may protect the optoelectronic chips and gold wires on the circuit board 300. Costs related to the molds and parts of the shielding bracket 1400 are low, and precision requirements of the product are not high. The shielding bracket 1400 may be easily assembled with the circuit board 300 and can be assembled manually by an operator.

In some embodiments, some optoelectronic chips on the circuit board 300 may have various electromagnetic wave radiation problems when working, which may easily cause the electromagnetic interference (EMI) of the optical module to exceed the standard, and the shielding bracket 1400 may not efficiently shield the electromagnetic wave radiation. Therefore, a shielding cover is provided to shield the optoelectronic chips and other major radiation devices so as to effectively solve the electromagnetic interference problem of the optical module.

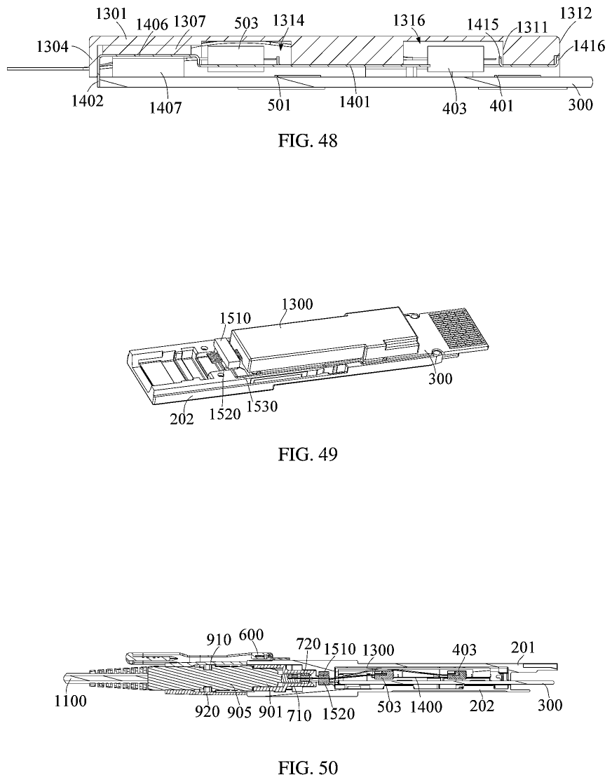

FIG. 46 is a structural diagram of a shielding cover of an optical module provided according to some embodiments of the present disclosure, FIG. 47 is a sectional view of a circuit board and a shielding component of an optical module provided according to some embodiments of the present disclosure in an assembled state, and FIG. 48 is a diagram of a circuit board and a shielding component of an optical module provided according to some embodiments of the present disclosure in an assembled state, which is shown at another angle. As shown in FIG. 46, FIG. 47 and FIG. 48, the shielding cover 1300 includes a top plate 1301 and a first side wall 1302, a second side wall 1303, a third side wall 1304 and a fourth side wall 1312 that are fixedly connected to the top plate 1301. The first side wall 1302 and the second side wall 1303 are arranged opposite to each other, the third side wall 1304 and the fourth side wall 1312 are arranged opposite to each other; and two ends of the third side wall 1304 and the fourth side wall 1312 are fixedly connected to the first side wall 1302 and the second side wall 1303, respectively, such that the top plate 1301, the first side wall 1302, the second side wall 1303, the third side wall 1304 and the fourth side wall 1312 form the shielding cover with an opening at the lower end.

When the shielding cover 1300 is placed on the circuit board 300, the shielding bracket 1400 is located between the shielding cover 1300 and the circuit board 300; the shielding cover 1300 is supported and fixed by the shielding bracket 1400, such that the shielding cover 1300 is fully enclosed, which can prevent thermal conductive glue particles or solder particles from damaging the optoelectronic chips or gold wires.

In some embodiments, the shielding cover 1300 is covered on the circuit board 300; the third side wall 1304 is mounted on the shielding plate 1402 of the shielding bracket 1400; and the first side wall 1302, the second side wall 1303 and the fourth side wall 1312 are supported on the circuit board 300. In this way, the shielding bracket 1400 supports the shielding cover 1300, and the shielding bracket 1400 and the shielding cover 1300 are combined to form a shielding component, which is sealingly connected to the circuit board 300, achieving the EMC shielding through the shielding component, and thus achieving better shielding effect.

The third side wall 1304 is formed thereon with an avoidance groove 1305. The avoidance groove 1305 is extended from a bottom surface of the third side wall 1304 toward the top plate 1301. When the shielding cover 1300 is placed on the shielding bracket 1400, the first optical fiber ribbon 410 and the second optical fiber ribbon 510 pass through the avoidance groove 1305 and are inserted into the optical fiber plug 720.

Referring to FIG. 46, an accommodation groove 1306 is formed on an inner side of the top plate 1301. The accommodation groove 1306 is recessed relative to the inner side of the top plate 1301. The accommodation groove 1306 includes a first groove wall 1311. The first groove wall 1311 is located between the third side wall 1304 and the fourth side wall 1312. After the shielding cover 1300 is placed on the shielding bracket 1400, the first protective wall 1415 of the shielding bracket 1400 abuts the first groove wall 1311, and the first groove wall 1311 is located at the right side of the first protective wall 1415, such that the shielding cover 1300 is positioned and limited in the left-right direction through the first protective wall 1415.

Referring to FIG. 46 and FIG. 48, in some embodiments, the fourth side wall 1312 is formed thereon with a positioning groove 1313, and the positioning groove 1313 extends from a bottom surface of the fourth side wall 1312 toward the top plate 1301. The positioning groove 1313 is recessed from the inner side surface of the top plate 1301. A third protective wall 1416 is provided on the right side surface of the bracket body 1401, and the third protective wall 1416 extends from the right edge of the bracket body 1401 toward the upper shell part 201 and is parallel to the first protective wall 1415. After the shielding cover 1300 is placed on the shielding bracket 1400, the third protective wall 1416 of the shielding bracket 1400 is inserted into the positioning groove 1313, so as to position the shielding cover 1300 through the third protective wall 1416 and the positioning groove 1313.

In some embodiments, a distance between the first protective wall 1415 and the third protective wall 1416 in the left-right direction may be slightly greater than or equal to a distance between the first groove wall 1311 and a left side wall of the positioning groove 1313 in the left-right direction, so as to limit the shielding cover 1300 in the left-right direction through the first protective wall 1415 and the third protective wall 1416, to avoid electromagnetic radiation problem caused by displacement of the shielding cover 1300.

The accommodation groove 1306 also includes a second groove wall 1308, a third groove wall 1309 and a fourth groove wall 1310. The second groove wall 1308, the third groove wall 1309 and the fourth groove wall 1310 are formed on the first side wall 1302 along the left-right direction. The fourth groove wall 1310 is connected to the first groove wall 1311, and bottom surfaces of the second groove wall 1308, the third groove wall 1309 and the fourth groove wall 1310 are flush with each other.

A fifth groove wall, a sixth groove wall and a seventh groove wall are formed on the second side wall 1303 in the left-right direction, and bottom surfaces of the fifth groove wall, the sixth groove wall and the seventh groove wall are flush with each other; the second groove wall 1308 is arranged opposite to the fifth groove wall, and the second groove wall 1308 and the fifth groove wall form a first accommodation groove 1314; the third groove wall 1309 is arranged opposite to the sixth groove wall, and the third groove wall 1309 and the sixth groove wall form a second accommodation groove 1315; the fourth groove wall 1310 is arranged opposite to the seventh groove wall, and the fourth groove wall 1310 and the seventh groove wall form a third accommodation groove 1316.

The first accommodation groove 1314, the second accommodation groove 1315 and the third accommodation groove 1316 are communicated with each other; the first avoidance hole 1409 is located in the third accommodation groove 1316, the second avoidance hole 1404 is located in the first accommodation groove 1314, and the first optical fiber ribbon 410 is located in the second accommodation groove 1315.

In some embodiments, the first accommodation groove 1314 has a first width, the second accommodation groove 1315 has a second width, the third accommodation groove 1316 has a third width, wherein the first width may be the same as the third width, the first width is larger than the second width, and the first width is smaller than the width between the first side wall 1302 and the second side wall 1303.

A first contact plate 1307 and a second contact plate are arranged in the accommodation groove 1306. The first contact plate 1307 extends from the left side surface of the second groove wall 1308 to the third side wall 1304, and the second contact plate extends from the left side surface of the fifth groove wall to the third side wall 1304. After the shielding cover 1300 is covered on the circuit board 300, a height between the first contact plate 1307 and the circuit board 300 is the same as a height between the second contact plate and the circuit board 300, and the height between the first contact plate 1307 and the circuit board 300 is greater than a height between the second groove wall 1308 and the circuit board 300.

Referring to FIG. 48, when the shielding cover 1300 is placed on the circuit board 300, the first support plate 1405 of the shielding bracket 1400 supports and connects with the first contact plate 1307, and the second support plate 1406 supports and connects with the second contact plate, so as to support the shielding cover 1300 by the shielding bracket 1400.

In the optical module provided according to the embodiments of the present disclosure, the shielding cover 1300 is covered on the circuit board 300, and the shielding cover 1300 supports the shielding bracket 1400. In this way, with the combination of the shielding cover 1300 and the shielding bracket 1400, the shielding cover 1300 is fully enclosed with the circuit board 300, achieving excellent EMC shielding effect and dust-proof effect. Meanwhile, it can protect the optical path from being polluted by silicone oil, sulfur-containing substances, residual small molecules of the internal elements of the optical module, such as the thermal conductive material and the absorbing material.

In some embodiments, an outer side surface of the shielding cover 1300 is in contact with an inner side surface of the upper shell part 201, and heats of the elements in the shielding cover 1300 is conducted to the upper shell part 201 through the shielding cover 1300. Since the shielding cover 1300 has a large surface area, the heat dissipation area is increased, thereby improving the heat dissipation performance of the optical module.

In some embodiments, considering that some electromagnetic radiation may escape from the avoidance groove 1305 on the shielding cover 1300 even with the shielding cover 1300 to shield the optoelectronic chips on the circuit board 300, which would affect the EMC shielding effect of the optical module, a conductive member may be provided between the upper shell part 201 and the lower shell part 202 so as to improve the EMC shielding effect of the optical module. The conductive member is in full contact with inner sides of the upper shell part 201 and the lower shell part 202, the optical fiber ribbon passing through the shielding cover 1300 passes through the conductive member, so as to achieve EMC shielding through the sealing of the conductive member, the upper shell part 201 and the lower shell part 202.

FIG. 49 is a diagram of a circuit board, a shielding component and a lower shell part of an optical module provided according to some embodiments of the present disclosure in an assembled state. As shown in FIG. 24 and FIG. 49, the upper shell part 201 is formed with the first mounting groove 2015, and the first mounting groove 2015 has an opening on the side thereof facing the lower shell part 202, such that the first mounting groove 2015 is formed as a U-shaped groove with an opening on the lower side; the lower shell part 202 is formed thereon with a second mounting groove, which has an opening on the side of the second mounting groove facing the upper shell part 201, such that the second mounting groove is formed as a U-shaped groove with an opening on the upper side. When the upper shell part 201 is covered on the lower shell part 202, the first mounting groove 2015 and the second mounting groove form a complete square groove, and the conductive member is located in the square groove to achieve a sealed connection between the conductive member, the upper shell part 201 and the lower shell part 202.

The conductive member includes a first conductive member 1510 and a second conductive member 1520. The first conductive member 1510 is placed in the first mounting groove 2015, a top surface of the first conductive member 1510 is seamlessly connected with a mounting surface of the first mounting groove 2015, and side surfaces of the first conductive member 1510 are seamlessly connected with side walls of the first mounting groove 2015, such that the first conductive member 1510 is seamlessly connected with the first mounting groove 2015 to ensure sufficient contact between the first conductive member 1510 and the upper shell part 201.

The second conductive member 1520 is placed in the second mounting groove, a bottom surface of the second conductive member 1520 is seamlessly connected with a mounting surface of the second mounting groove, and side surfaces of the second conductive member 1520 are seamlessly connected with side walls of the second mounting groove, such that the second conductive member 1520 is seamlessly connected with the second mounting groove to ensure that the second conductive member 1520 is in full contact with the lower shell part 202. Exemplarily, the first conductive member 1510 may be a first elastic conductive member, and the second conductive member 1520 can be a second elastic conductive member. Of course, the two conductive members may also be other forms of conductive members, which is not limited in the embodiments of the present disclosure.

In some embodiments, the first optical fiber ribbon 410 and the second optical fiber ribbon 510 pass through the connection between the first conductive member 1510 and the second conductive member 1520. The first conductive member 1510 and the second optical fiber ribbon 510 may support the first conductive member 1510 and the second conductive member 1520, and the gap between the upper shell part 201 and the lower shell part 202 may be filled through the first conductive member 1510 and the second conductive member 1520.

In some embodiments, the lower shell part 202 is formed thereon with two third mounting grooves 2024, the two third mounting grooves 2024 are located on opposite sides of the second mounting groove, and the two third mounting grooves 2024 are communicated with the second mounting groove. Conductive adhesive strips 1530 are respectively arranged in the two third mounting grooves 2024, and the conductive adhesive strips 1530 can make the upper shell part 201 and the lower shell part 202 fully contact with each other except the first mounting groove 2015 and the second mounting groove.

The conductive adhesive strip 1530 is connected with a surface of the second conductive member 1520, and the conductive adhesive strip 1530 fills the gap between the upper shell part 201 and the lower shell part 202, so that the upper shell part 201 and the lower shell part 202 are in full contact, and thus the upper shell part 201, the first conductive member 1510, the second conductive member 1520, the conductive adhesive strips 1530 and the lower shell part 202 form a closed cavity, and electromagnetic radiation inside the closed cavity cannot leak out, thereby effectively reducing the electromagnetic radiation, and achieving good electromagnetic shielding effect.

In some embodiments, the first conductive member 1510 and the second conductive member 1520 may be conductive gaskets or conductive foams.

FIG. 50 is a sectional view of an optical module provided according to some embodiments of the present disclosure. As shown in FIG. 50, the first optical emission chip 401, the first optical reception chip 402 and the first optical fiber-bracket 403 of the first optical component 400 are mounted on the circuit board 300, the first optical fiber ribbon 410 is inserted into the first optical fiber-bracket 403, and the reflection surface of the optical fiber in the first optical fiber ribbon 410 is placed directly above the first optical emission chip 401 and the first optical reception chip 402; the second optical emission chip 501, the second optical reception chip 502 and the second optical fiber-bracket 503 of the second optical component 500 are mounted on the circuit board 300; the second optical fiber ribbon 510 is inserted into the second optical fiber-bracket 503, and the reflection surface of the optical fiber in the second optical fiber ribbon 510 is placed directly above the second optical emission chip 501 and the second optical reception chip 502.

The shielding bracket 1400 is placed on the circuit board 300, the shielding plate 1402 is mounted on the left side surface of the circuit board 300, and the bent plates 1403 on the shielding plate 1402 are attached on the side surfaces of the circuit board 300, such that the first optical emission chip 401, the first optical reception chip 402 and the first optical fiber-bracket 403 are located in the first avoidance hole 1409; and the second optical emission chip 501, the second optical reception chip 502 and the second optical fiber-bracket 503 are located in the second avoidance hole 1404.

The shielding cover 1300 is placed on the circuit board 300 and supported by the shielding bracket 1400. The third side wall 1304 of the shielding cover 1300 is mounted on the shielding plate 1402 of the shielding bracket 1400. The first protective wall 1415 and the third protective wall 1416 of the shielding bracket 1400 position and limit the shielding cover 1300 in the left-right direction, such that the shielding cover 1300 and the circuit board 300 are fully enclosed and assembled through the combination of the shielding cover 1300 and the shielding bracket 1400, thereby realizing EMC shielding of the optoelectronic chips and the gold wires.

The unlocking component 600 is designed to be rotatable, and the handle 610 of the unlocking component 600 can be rotated to expose the optical port of the optical module, which is convenient for assembling the anti-disassembly structure of the AOC optical cable at the production end and also convenient for the client to use it in the relevant device.

The optical cable 1100 is inserted into the optical fiber adapter 700 through the optical cable plug 900 to convert the non-AOC optical module into an AOC optical module. One non-AOC optical module may be used to realize functions of both non-AOC and AOC optical modules, thereby improving the switching efficiency between non-AOC optical modules and AOC optical modules.

A pair of first protective cover 910 and second protective cover 920 that can be engaged up and down are mounted on the optical cable plug 900, and the sleeve 905 of the optical cable plug is locked through the locking bosses on the protective covers, such that the sleeve 905 cannot slide on the connecting portion 906; and the first engaging part 7101 of the claw member 710 is locked through the sleeve 905, thereby ensuring a stable connection between the optical cable plug 900 and the claw member 710, and preventing the optical cable plug 900 from being abnormally disassembled.

Finally, it should be noted that the above embodiments are only used to illustrate the technical solutions of the present disclosure, rather than to limit them. Although the present disclosure has been described in detail with reference to the aforementioned embodiments, those skilled in the art should understand that they can still modify the technical solutions described in the aforementioned embodiments, or make equivalent replacements for some of the technical features therein. However, these modifications or replacements do not deviate the essence of the corresponding technical solutions from the spirit and scope of the technical solutions of the embodiments of the present disclosure.

1. An optical module, comprising:
an optical component;
an optical fiber adapter connected to the optical component via an optical fiber ribbon;
an optical cable plug, one end of the optical cable plug being inserted into the optical fiber adapter, wherein the optical cable plug comprises:
a base, one end of the base being inserted into the optical fiber adapter, and a limiting groove is provided on the base;
a sleeve, the sleeve being sleeved on the base and slidably connected to the base, and the optical cable plug and the optical fiber adapter can be locked or disassembled by moving the sleeve; and
an anti-unlocking component arranged on the optical cable plug, wherein a locking mechanism is disposed inside the anti-unlocking component, and the locking mechanism is embedded in the limiting groove to lock and limit the sleeve.

2. The optical module according to claim 1, wherein the anti-unlocking component comprises a protective cover that is disposed on the sleeve; and the locking mechanism comprises a locking boss formed on an inner surface of the protective cover, and the locking boss is embedded in the limiting groove.

3. The optical module according to claim 2, wherein the protective cover comprises a first protective cover and a second protective cover, wherein the first protective cover and the second protective cover are engaged to each other, the sleeve is located inside the first protective cover and the second protective cover; and the locking boss is formed inside the first protective cover and the second protective cover.

4. The optical module according to claim 3, wherein the first protective cover and the second protective cover have the same structure; and the first protective cover and the second protective cover are engaged to each other via a positioning post and a positioning hole.

5. The optical module according to claim 4, wherein the first protective cover comprises:
a cover plate, the cover plate is covered on the sleeve and comprises a first cover plate and a second cover plate, wherein the second cover plate faces the optical fiber adapter, a width of the first cover plate is smaller than a width of the second cover plate, and the locking boss is arranged on an inner side of the second cover plate;
a first side plate, one end of the first side plate being fixedly connected to the cover plate; and
a second side plate, one end of the second side plate being fixedly connected to the cover plate, wherein the second side plate is arranged opposite to the first side plate, and the locking boss is connected to the first side plate and/or the second side plate.

6. The optical module according to claim 5, wherein two limiting grooves are formed on the base, and the two limiting grooves are not communicated to each other;
the locking boss comprises a first locking boss and a second locking boss which are arranged on the inner side of the second cover plate, wherein one end of the first locking boss is fixedly connected to an inner side of the first side plate, one end of the second locking boss is fixedly connected to the inner side of the second side plate, there is a gap between the first locking boss and the second locking boss, and the first locking boss and the second locking boss are respectively embedded in the two limiting grooves.

7. The optical module according to claim 6, wherein the first locking boss and the second locking boss are U-shaped ribs.

8. The optical module according to claim 6, wherein the first locking boss has the same structure as the second locking boss, the first locking boss comprises two ribs, one end of each rib is fixedly connected to the first side plate, there is a gap between the two ribs in an optical transmission direction of the optical cable plug, and one rib is embedded in the limiting groove and abuts against the sleeve.

9. The optical module according to claim 6, wherein the first locking boss and the second locking boss have the same structure, the first locking boss is a raised platform with a certain wall thickness, the raised platform is embedded in the limiting groove, and one side of the raised platform abuts against the sleeve.

10. The optical module according to claim 2, further comprising an upper shell part and a lower shell part, wherein the upper shell part covers on the lower shell part, and the optical fiber adapter is located in a cavity formed by the upper shell part and the lower shell part;
wherein an upper cover plate of the upper shell part is formed thereon with a baffle, and there is a gap between one side of the baffle and one side of the upper shell part;
one end of the sleeve is inserted into an optical port formed by the upper shell part and the lower shell part, one end surface of the sleeve abuts against the baffle, and one end of the protective cover abuts against end surfaces of the upper shell part and the lower shell part.

11. The optical module according to claim 10, wherein one side of the upper shell part facing the optical cable plug is formed thereon with a limiting groove, the limiting groove being recessed relative to the side of the upper shell part facing the optical cable plug; and one side of the protective cover facing the upper shell part is embedded in the limiting groove.

12. The optical module according to claim 1, wherein,
the anti-unlocking component comprises a connecting mechanism connected to an outer side of one end of the base; and the locking mechanism is arranged on an inner side of the connecting mechanism.

13. The optical module according to claim 12, wherein the connecting mechanism comprises a first connecting member and a second connecting member, wherein each of the first connecting member and the second connecting member comprises:
a bridging portion, the locking mechanism is arranged on an inner side of the bridging portion;
a first connecting portion located at one end of the bridging portion, the first connecting portion is assembled and connected to a side surface of the base, and is formed thereon with an engaging part;
a second connecting portion located at the other end of the bridging portion, the second connecting portion is assembled and connected to the side surface of the base, and is formed thereon with an engaging groove;
wherein the engaging part on the first connecting member is detachably connected in the engaging groove on the second connecting member, and the engaging part on the second connecting member is detachably connected in the engaging groove on the first connecting member.

14. The optical module according to claim 13, wherein a width of the bridge portion is smaller than a width of the first connecting portion, and the width of the bridge portion is smaller than a width of the second connecting portion;
the locking mechanism comprises a first locking protrusion and a second locking protrusion, wherein the first locking protrusion connects the first connecting portion and the bridging portion, and the second locking protrusion connects the second connecting portion and the bridging portion; and
the first locking protrusion and the second locking protrusion are embedded in the limiting groove.

15. The optical module according to claim 14, wherein the first locking protrusion is formed thereon with a first blocking surface, the second locking protrusion is formed thereon with a third blocking surface, and the bridging portion is formed thereon with a second blocking surface;
a width of the first locking protrusion is smaller than the width of the bridging portion, and a width of the second locking protrusion is smaller than the width of the bridging portion;
the first blocking surface, the second blocking surface and the third blocking surface are flush with each other; the first blocking surface, the second blocking surface and the third blocking surface block the end surface of the sleeve; and a surface of the bridging portion is located at a higher level than a surface of the sleeve.

16. The optical module according to claim 13, wherein the locking mechanism comprises a first limiting rib and a second limiting rib, wherein
the first limiting rib extends from one end of the bridging portion to the other end of the bridging portion, an end of the first limiting rib connects with the first connecting portion, and an end of the second limiting rib connects the second connecting portion;
there is a gap between an inner side surface of the first limiting rib and an inner side surface of the second limiting rib, an outer side surface of the first limiting rib blocks and connects with the end surface of the sleeve, and an outer side surface of the second limiting rib abuts against a groove wall on one side of the limiting groove away from the sleeve.

17. The optical module according to claim 1, further comprising:
an upper shell part;
a lower shell part, wherein the upper shell part is covered on the lower shell part, and the optical fiber adapter is located in a cavity formed by the upper shell part and the lower shell part; and
an unlocking component comprising a handle and an unlocker, wherein the unlocker is engaged on side plates of the upper shell part, and the handle is rotatably connected to the unlocker.

18. The optical module according to claim 17, wherein a shaft sleeve is formed at one end of the unlocker; one end of the handle facing the unlocker is formed thereon with an avoidance groove, a rotating shaft is arranged in the avoidance groove, and there is a gap between a side surface of the rotating shaft facing away from the unlocker and a side surface of the avoidance groove facing the unlocker; and the shaft sleeve passes through the avoidance groove and is sleeved on the rotating shaft.

19. The optical module according to claim 18, wherein the unlocker comprises:
a cross arm, wherein the cross arm is located on an outer side of the upper shell part, the shaft sleeve is located on the cross arm, and the handle is rotatably connected to the shaft sleeve;
a first unlocking arm, one end of the first unlocking arm is fixedly connected to the cross arm, and the first unlocking arm is engaged on one upper side plate of the upper shell part; and
a second unlocking arm, one end of the second unlocking arm is fixedly connected to the cross arm, the second unlocking arm and the first unlocking arm are located on opposite sides of the cross arm, and the second unlocking arm is engaged on the other upper side plate of the upper shell part.

20. The optical module according to claim 1, wherein the optical fiber adapter comprises a claw member and an optical fiber plug, and wherein the optical fiber plug is inserted into the claw member, and the optical fiber plug is connected to the optical component through the optical fiber ribbon;
the base comprises: a plug-in portion inserted into the claw member and coupled with the optical fiber plug; and a connecting portion fixedly connected with the plug-in portion, wherein the connecting portion is located outside the claw member, and the limiting groove is located at an end of the connecting portion away from the plug-in portion; the connecting portion is formed, on opposite sides thereof, with second engaging grooves, and the second engaging grooves are located at one end of the connecting portion that is connected with the plug-in portion;
the claw member is formed, on opposite sides thereof, with slots, wherein a first engaging part is provided in the slot, one end of the first engaging part being fixedly connected to the claw member, the other end of the first engaging part being engaged in the second engaging groove, and the sleeve clamps the first engaging part when moving.
